(19) United States
(12) Patent Application Publication
(10) Pub. No.: US 2009/0142517 A1
(43) Pub. Date: Jun. 4, 2009

(54) POLARIZING FILM WITH ADHESIVE, OPTICAL LAMINATE, AND SET OF POLARIZING FILMS

(75) Inventors: Ryu Takeko, Ehime (JP); Masako Sugihara, Osaka (JP); Yuuhei Inokuchi, Ehime (JP); Ju Yeul Jang, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, CHUO-KU, TOKYO (JP)

(21) Appl. No.: 12/302,153

(22) PCT Filed: May 24, 2007
(86) PCT No.: PCT/JP2007/061043

§ 371 Date: Feb. 6, 2009

(30) Foreign Application Priority Data
May 26, 2006 (JP) 2006-146384

(51) Int. Cl. C09K 19/52; B32B 27/32; B05D 3/14; B32B 27/36

(52) U.S. Cl. 428/1.31; 428/523; 428/480; 428/332; 427/533

(57) ABSTRACT

Disclosed is a polarizing film (10) with an adhesive comprising a polarizing film (15) having a structure of amorphous cyclic polyolefin resin film (12)/polarizer (13)/protection film (14) and an adhesion layer (11) provided on an outer side of the amorphous cyclic polyolefin resin film (14), wherein the adhesion layer (11) has a gel content of 75 to 95 wt %. An optical laminate is obtained by bonding this polarizing film with adhesive (10) to one surface of a liquid crystal display glass cell (35). The second polarizing film (25) having a structure of protection film (22)/polarizer (23)/protection film (24) is bonded to the other surface of the glass cell (35) with interposing the second adhesion layer (21). When the protection film (22) is made from acetylcellulose, the second adhesion layer (21) is composed of a material having a low gel content.

### FIELD OF THE INVENTION

The present invention relates to a polarizing film with an adhesive to be used as being bonded to a glass cell for a liquid crystal display, an optical laminate obtained by bonding the polarizing film to a glass cell for a liquid crystal display, and a set of polarizing films to be bonded to the both sides of a glass cell for a liquid crystal display. The present invention also relates to a method for producing a polarizing film with an adhesive.

### BACKGROUND ART

A glass cell for a liquid crystal display, which is generally used for liquid crystal display devices such as those in TN (Twisted Nematic) and STN (Super Twisted Nematic) modes, has a structure comprising a liquid crystal component held between a pair of glass substrates. Optical films such as a polarizing film, a phase difference film, and an anti-reflection film are laminated on the surface of each glass substrate with an adhesive containing an acrylic resin as a main component. On the display side surface of the polarizing film, a surface treatment layer such as an anti-reflection layer is often provided. Therefore, in general, an optical laminate obtained by laminating a surface treatment layer, a polarizing film, an adhesion layer a glass cell for a liquid crystal display an adhesion layer and a polarizing film in this order is used.

Since the adhesion layers in such an optical laminate are subject to a large dimensional change which is caused by expansion and shrinkage occurring under heating or wet heating conditions, some problems such as foaming in the adhesion layers in the obtained optical laminate and warping and peeling between the adhesion layer and the glass substrate arise. Further, as the result of stress concentration on an outer peripheral part of the optical laminate caused by less uniform distribution of residual stress acting on the optical film such as the surface treatment layer and the polarizing film under heating or wet heating conditions, a phenomenon called “white spots” of causing the outer peripheral part to become whitish in displaying black undesirably occurs in the TN liquid crystal cell, while color irregularity in the outer peripheral part undesirably occurs in the STN liquid crystal cell.

Also, such a liquid crystal display device is used in a car navigation system for an automobile. In the case of automobile use, durability is required for a liquid crystal display device for preventing changes in appearance such as foaming, warping, peeling and clouding under high temperature and high humidity conditions.

In order to solve such problems, JP-A-2006-77224 discloses an adhesive obtainable by mixing a crosslinking agent with two types of acrylic resins having different weight average molecular weights to achieve a gel content of 10 to 50 wt %, and this patent application describes that an optical laminate obtained by bonding polarizing films to the both surfaces of a liquid crystal display glass cell with interposing this adhesive is suppressed in generation of white spots even when the laminate is exposed to a high temperature dry condition and a high temperature high humidity condition.

Further, in a case where there is a failure in bonding a polarizing film having an adhesion layer to a liquid crystal display glass cell, it is necessary to detach the polarizing film for re-bonding the polarizing film, and the polarizing film is required to have a so-called reworkability which allows the adhesion layer to be peeled off together with the polarizing film in the detachment and prevents the adhesion layer from remaining on the glass substrate as well as clouding. The above patent application describes that an optical film provided with an adhesion layer described therein is excellent in reworkability.

Many of polarizing films have a structure of sandwiching a polarizer made from a polyvinyl alcohol-based resin with protection films made from an acetylcellulose resin such as triacetylcellulose, and an attempt is made to replace at least one of the protection films with an amorphous cyclic polyolefin resin film comprising norbornene or the like as a monomer. For example, JP-A-8-43812 discloses the use of a film made from a thermoplastic norbornene resin and having a phase difference function as at least one of the protection films in a polarizing film obtained by laminating the protection films on both sides of a polarizer. Also, JP-A-2005-208456 discloses a structure of laminating a cyclic polyolefin resin film on one surface of a polarizer made from a polyvinyl alcohol resin and laminating an acetylcellulose-based film on the other surface.

It has been revealed that, when an adhesive having a low gel content and high flexibility as disclosed in JP-A-2006-77224 is applied to the both surfaces of a glass substrate in the case of laminating the first polarizing film having a structure of amorphous cyclic polyolefin resin film/polarizer/protection film on one surface of a liquid crystal display glass cell at the amorphous cyclic polyolefin resin film side with interposing an adhesion layer and laminating the second polarizing film obtained by bonding acetylcellulose-based protection films to the both surfaces of a polarizer to the other surface with interposing an adhesion layer, warping and peeling as well as foaming occur between the adhesion layer and the amorphous cyclic polyolefin resin film and the durability becomes insufficient due to the insufficient coagulation force of the adhesive in the case of being left at a high temperature (e.g. 80° C. dry condition) for a long time (e.g. 100 hours). Also, it has been revealed that the same problem occurs in laminating a polarizing film having a structure of amorphous cyclic polyolefin resin film/polarizer/protection film on the both surfaces of a liquid crystal display glass cell at an amorphous cyclic polyolefin resin film side with interposing an adhesion layer when the adhesive having a low gel content and exhibiting high flexibility is used.

Therefore, one object of the present invention is to provide a polarizing film having an adhesive which is suppressed in generation of white spots, prevents appearance changes such as warping, peeling, foaming and clouding, is excellent in durability when the polarizing film is used for a liquid crystal display device and exposed to high temperature or high temperature high humidity conditions or repeatedly heated and cooled, and is capable of suppressing white spots even in large size displays. Another object of the present invention is to provide an optical laminate in which the polarizing film having an adhesive is used for a liquid crystal display glass cell as well as to provide a set of polarizing films wherein the polarizing film with the adhesive is used as one of the polarizing films to be bonded to the liquid crystal display glass cell.

### DISCLOSURE OF THE INVENTION

As the result of an extensive research in order to achieve the above-described objects, it has been found that it is effective to apply an adhesive having a high gel content for a polarizing film obtained by bonding an amorphous cyclic polyolefin-based resin film to one surface of a polarizer. Also, it has been found that it is more effective to use different adhesives as adhesives to be applied to the both surfaces of a liquid crystal display glass cell in the case of laminating the first polarizing film having a structure of amorphous cyclic polyolefin resin film/polarizer/protection film at the amorphous cyclic polyolefin resin film side to one surface of the liquid crystal display glass cell with interposing the first adhesion layer and laminating to the other surface of the glass cell the second polarizing film obtained by bonding acetylcellulose-based protection films to the both surfaces of a polarizer. Further, it has been found that, in the case of laminating a polarizing film having a structure of amorphous cyclic polyolefin resin film/polarizer/protection film at the amorphous cyclic polyolefin resin film side to each of the both surfaces of a liquid crystal display glass cell with interposing an adhesion layer, it is advantageous to form each of the adhesion layers from an adhesive having a high gel content. The present invention has been accomplished based on the above-described findings and various further studies.

According to the first aspect of the present invention, there is provided a polarizing film with an adhesive comprising a polarizing film having a structure of amorphous cyclic polyolefin resin film/polarizer/protection film and an adhesion layer provided on an outer side of the amorphous cyclic polyolefin resin film, wherein the adhesion layer has a gel content of 75 to 95 wt %. The adhesion layer is preferably formed from an adhesive obtained by mixing an acrylic resin with a crosslinking agent. A brightness-improving film may be laminated on an outer side of the protection film.

According to the second aspect of the present invention, there is provided an optical laminate wherein the polarizing film with the adhesive defined according to the first aspect is bonded to one surface of a liquid crystal display glass cell at the adhesion layer side of the polarizing film. According to one preferred embodiment of the optical laminate, the first polarizing film having a structure of amorphous cyclic polyolefin resin film/polarizer/protection film is bonded to one surface of the liquid crystal display glass cell at the amorphous cyclic polyolefin resin film side of the first polarizing film with interposing the first adhesion layer; and the second polarizing film in which an acetylcellulose-based protection film is bonded to each of surfaces of a polarizer is bonded to the other surface of the glass cell with interposing the second adhesion layer, the first adhesion layer has a gel content of 75 to 95 wt %, and the second adhesion layer has a gel content of 30 to 70 wt %. The second polarizing film may have a surface treatment layer on a surface opposite to the second adhesion layer.

According to another preferred embodiment of the optical laminate, the first polarizing film having a structure of amorphous cyclic polyolefin resin film/polarizer/protection film is bonded to one surface of the liquid crystal display glass cell at the amorphous cyclic polyolefin resin film side of the first polarizing film with interposing the first adhesion layer; and the second polarizing film having a structure of amorphous cyclic polyolefin resin film/polarizer/protection film is bonded to the other surface of the glass cell at the amorphous cyclic polyolefin resin film side of the second polarizing film with interposing the second adhesion layer, and each of the first adhesion layer and the second adhesion layer has a gel content of 75 to 95 wt %. Also, in this case, the second polarizing film may have a surface treatment layer on a surface opposite to the second adhesion layer.

According to the third aspect of the present invention, there is provided a set of polarizing films for a liquid crystal display device. The set of polarizing films is a combination of the first polarizing film with an adhesive and the second polarizing film with an adhesive, wherein the first polarizing film with the adhesive comprises the first polarizing film having a structure of amorphous cyclic polyolefin resin film/polarizer/protection film and the first adhesion layer provided on an outer side of the amorphous cyclic polyolefin resin film; the second polarizing film with the adhesive comprises the second polarizing film in which an acetylcellulose-based protection film is bonded to each of the both surfaces of a polarizer and the second adhesion layer provided on one surface of the second polarizing film; the first adhesion layer has a gel content of 75 to 95 wt %; and the second adhesion layer has a gel content of 30 to 70 wt %.

According to the fourth aspect of the present invention, there is provided a method for producing a polarizing film with an adhesive wherein, when an adhesion layer is provided on an amorphous cyclic polyolefin resin film side of a polarizing film having a structure of amorphous cyclic polyolefin resin film/polarizer/protection film, the adhesion layer is provided on a surface of the amorphous cyclic polyolefin resin film of the polarizing film with adjusting a gel content of the adhesion layer to 75 to 95 wt %.

Since the polarizing film having the structure of amorphous cyclic polyolefin resin film/polarizer/protection film has a small photoelastic coefficient of the amorphous cyclic polyolefin resin film and suffers from less phase difference change, white spots attributed to the resin film hardly occurs, but the polarizing film tends to suffer from foaming, warping, peeling, and the like due to the weak adhesion force of the amorphous cyclic polyolefin resin film. Therefore, in the polarizing film with the adhesive of the present invention, the adhesive having a high gel content and a large aggregation force is used for the adhesion layer for bonding to the liquid crystal display glass cell at the amorphous cyclic polyolefin resin film side, and thereby the occurrence of foaming, warping, peeling, and the like is suppressed. The polarizing film with the adhesive is excellent in reworkability in bonding to the liquid crystal display glass cell.

The optical laminate of the present invention is obtained by bonding the above-described polarizing film with the adhesive to one surface of the liquid crystal display glass cell and is capable of suppressing the occurrence of foaming, warping, peeling, and the like otherwise caused by a temperature change or the like. In a preferred embodiment of the optical laminate, since the first polarizing film comprising the amorphous cyclic polyolefin resin film as one component is laminated on one surface of the liquid crystal display glass cell with interposing the first adhesion layer having a high gel content and a large aggregation force, and further the second polarizing film obtained by bonding the acetylcellulose-based protection film to each of the both surfaces of the polarizer is laminated on the other surface of the glass cell with interposing the second adhesion layer having a low gel content and a small aggregation force, it is possible to absorb and alleviate a stress caused by the dimensional change of the second polarizing film and the dimensional change of a glass substrate between the second polarizing film and the glass cell under a heat resistant condition by the second adhesion layer, thereby making it possible to reduce local stress concentration, to suppress warping and peeling of the adhesion layer from the glass substrate, as well as to prevent optical defects such as white spots caused by non-uniform stress distribution.

According to another preferred embodiment of the optical laminate, the first polarizing film comprising the amorphous cyclic polyolefin resin film as one component is laminated on one surface of the liquid crystal display glass cell with interposing the first adhesion layer having a high gel content and a large aggregation force, and the first polarizing film comprising the amorphous cyclic polyolefin resin film as one component is also laminated on the other surface of the liquid crystal display glass cell with interposing the first adhesion layer having a high gel content and a large aggregation force. With this embodiment, since the amorphous cyclic polyolefin resin film has a low photoelastic coefficient under the heat resistant condition, it is possible to prevent optical defects such as white spots attributed to the non-uniform stress distribution. Also, the use of the adhesive having a high gel content and a large aggregation force as the adhesion layer makes it possible to suppress the warping and peeling of the adhesion layer from the glass substrate.

In view of the above, white spots are suppressed in the case where the glass substrate forming the optical laminate is a TN liquid crystal cell, and color irregularity is suppressed in the case where the glass substrate is a STN liquid crystal cell. Such an optical laminate does not suffer from white spots, and is free from appearance changes such as warping, peeling, foaming and clouding, and excellent in durability even when heating is repeated and, even when the size is increased to 15 inches or more, and further can suppress optical defects such as white spots and color irregularity.

Also, in the case where the first polarizing film or the second polarizing film is detached from the glass substrate of the liquid crystal display glass cell together with the first adhesion layer or the second adhesion layer, respectively, since adhesive deposit and clouding hardly occur on the glass substrate after the detachment, it is possible to attach another polarizing film again to the glass cell, thereby achieving excellent reworkability.

In the set of polarizing films according to the present invention, since the first polarizing film with the adhesive is obtained by disposing the first adhesion layer having a high gel content and a large aggregation force on the amorphous cyclic polyolefin resin film side of the first polarizing film having the structure of amorphous cyclic polyolefin resin film/polarizer/protection film, and also the second polarizing film with the adhesive is obtained by disposing the second adhesion layer having a low gel content and a small aggregation force on one surface of the second polarizing film obtained by bonding the acetylcellulose-based protection film to each of the both sides of the polarizer, an adhesion force at the first polarizing film is increased when each of the films is bonded to the liquid crystal display glass cell, and it is possible to absorb and alleviate a stress, when a stress occurs due to a dimensional change accompanying a temperature change or the like at the second polarizing film side. Therefore, the local stress concentration is reduced, the warping and peeling of the adhesion layer from the glass substrate are suppressed, and optical defects such as white spots caused by non-uniform stress distribution are prevented.

Also, according to the production method for a polarizing film with an adhesive of the present invention, it is possible to advantageously produce a polarizing film with an adhesive wherein the amorphous cyclic polyolefin resin film is used as one of the protection films of the polarizer, and the adhesion layer is provided on a surface thereof.

### BRIEF DESCRIPTION OF THE DRAWINGS

FIG. 1 is a schematic sectional view showing one example of a layer structure of a polarizing film with an adhesive according to the present invention.

FIG. 2 is a schematic sectional view showing one example of a polarizing film with an adhesive on which a brightness-improving film is laminated.

FIG. 3 is a schematic sectional view showing one example of a layer structure of an optical laminate according to the present invention.

FIG. 4 is a schematic sectional view showing one example of an optical laminate in which a brightness-improving film is laminated on a first polarizing film side, and a surface treatment layer is provided on the outer surface of the second polarizing film.

### DESCRIPTION OF REFERENCE NUMERALS

10: First polarizing film with adhesive
11: First adhesion layer
12: Amorphous cyclic polyolefin resin film
13: Polarizer
14: Protection film
15: First polarizing film
17: Brightness-improving film
20: Second polarizing film with adhesive
21: Second adhesion layer
22, 24: Protection films
23: Polarizer
25: Second polarizing film
27: Surface treatment layer
30: Optical laminate
35: Liquid crystal display glass cell

### MOST PREFERRED EMBODIMENTS OF THE INVENTION

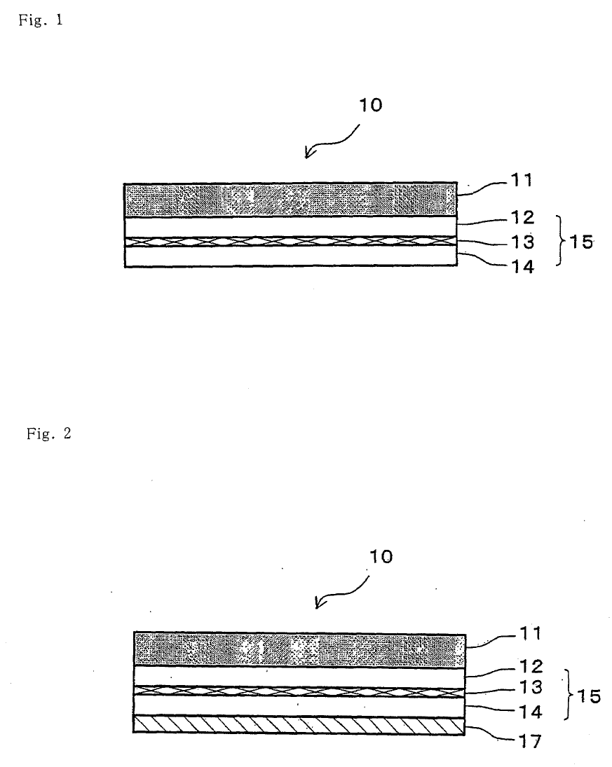

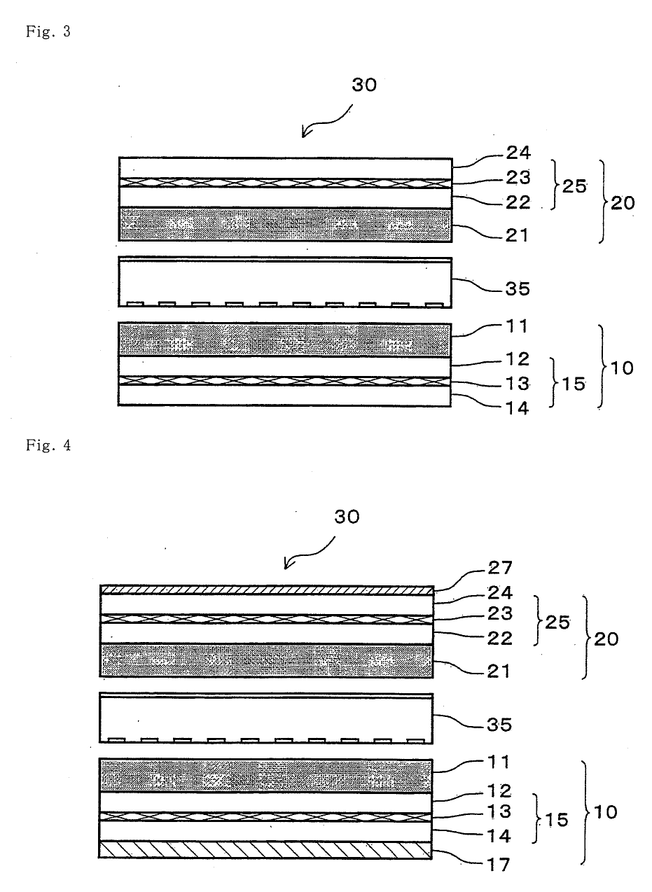

Shown in FIG. 1 is a schematic sectional view of one example of a layer structure of a polarizing film with an adhesive according to the present invention, and shown in FIG. 2 is a schematic sectional view of one example in which a brightness-improving film is laminated on the polarizing film with the adhesive of FIG. 1. Shown in FIG. 3 is a schematic sectional view of one preferred mode of a layer structure of an optical laminate according to the present invention, and shown in FIG. 4 is a schematic sectional view of one example in which a brightness-improving film is laminated on an outer side of a protection film of the first polarizing film and a surface treatment layer is provided on a side opposite to an adhesion layer of the second polarizing film in the optical laminate of FIG. 3. Embodiments of the present invention will be described in detail with reference to the drawings.

[Polarizing Film with Adhesive]

Firstly, a polarizing film with an adhesive will be described referring to FIG. 1 mainly and also to FIG. 2 if necessary. As shown in FIG. 1, the polarizing film 10 with the adhesive of the present invention has the first polarizing film 15 having a structure of amorphous cyclic polyolefin resin film 12/polarizer 13/protection film 14 and an adhesion layer 11 applied to the outer side of the amorphous cyclic polyolefin resin film 12.

The polarizer 13 constituting the polarizing film 15 has a function of emitting polarized light from incident light such as natural light. In general, such a polarized light emission function is expressed by a function of absorbing linear polarized light having a vibration plane in one direction and transmitting linear polarized light having a vibration plane orthogonal to the previously mentioned vibration plane. The polarizer 13 may be formed of a uniaxially drawn polyvinyl alcohol resin film and a dichromatic pigment such as iodine or a dichromatic dye adsorbed and oriented on the film. Such a polarizer is usually produced by performing uniaxial drawing, coloring with the dichromatic pigment, and boric acid treatment on the polyvinyl alcohol resin film.

On one side of the polarizer 13, a protection film formed of the amorphous cyclic polyolefin resin film 12 is disposed. Herein, the amorphous cyclic polyolefin resin is a resin comprising a cyclic olefin such as norbornene or polycyclic norbornene as a monomer and may be those obtained by saturating a hydrogenation degree by adding hydrogen to a ring opening polymer of the cyclic olefins or copolymers of a cyclic olefin and a linear olefin. Among others, a thermoplastic saturated norbornene resin is advantageously used. Also, those having a polar group introduced therein are effective. Examples of commercially available amorphous cyclic polyolefin resins include “ARTON” available from JSR Corporation, “ZEONEX” and “ZEONOR” available from Optes Inc., “APO” and “APEL” available from Mitsui Chemicals, Inc., and the like (those indicated with brackets are trade names). Since such amorphous cyclic polyolefin resins have a small photoelastic coefficient and hardly suffer from a phase difference change along with a temperature change and the like as described above, they are effective for suppressing white spots when used in a liquid crystal display device.

The thickness of the amorphous cyclic polyolefin resin film 12 is usually about 10 to 120 μm, preferably about 20 to 80 μm.

The amorphous cyclic polyolefin resin film 12 may be the one that is uniaxially or biaxially drawn to exhibit desired birefringence. In this case, a draw ratio is usually about 1.1 to 5 times, preferably 1.2 to 3 times, and an in-plane phase difference is usually about 20 to 200 nm. In the case of using the film exhibiting such birefringence, by disposing the film 12 so that a delayed phase axis thereof is in a parallel relationship or a orthogonal relationship with a transmission axis of the polarizer 13, it is possible to prevent deterioration of brightness and contract without being influenced by a phase difference caused by a transparent protection layer in a front direction that is perpendicular to the polarizing film plane, and, for visibility in an oblique direction, it is possible to enhance a region of good visibility which is free from a color change such as coloring and tone reversal and excellent in contrast and luminance by compensating for a state change of linear polarized light caused by the birefringence of liquid crystal cells, thereby enabling the production of a liquid crystal display device having a wide viewing angle.

On the other surface of the polarizer 13, the protection film 14 is disposed. A transparent resin film is used as the protection film 14. Examples of the transparent resin include acetylcellulose resins such as triacetylcellulose and diacetylcellulose, methacrylic resins such as polymethyl methacrylate, polyester resins, polyolefin resins, polycarbonate resins, polyetherether ketone resins, polysulfone resins, and the like. To the resin forming the protection film, a UV absorber such as a salicylic acid ester compound, a benzophenone compound, a benzotriazole compound, a triazine compound, a cyanoacrylate compound, or a nickel complex salt compound may be blended. The protection film 14 is suitably formed from an acetyl cellulose resin, and, particularly preferably a triacetylcellulose film is used. The thickness of the protection film 14 is usually about 30 to 120 μm.

For the bonding of the polarizer 13 and the amorphous cyclic polyolefin resin film 12 or the polarizer 13 and the protection film 14, a transparent adhesive is usually used. For example, a waterborne adhesive such as an aqueous solution of a polyvinyl alcohol resin is preferably used.

[Adhesion Layer of Polarizing Film with Adhesive]

The adhesion layer 11 is provided on the outer side (the side not facing to the polarizer 13) of the amorphous cyclic polyolefin resin film 12 forming the polarizing film 15. In the present invention, the gel content of the adhesion layer 11 is adjusted to 75 to 95 wt %. Hereinafter, the adhesion layer 11 will be described in detail.

The adhesion layer 11 is formed from an adhesive obtained by blending a crosslinking agent with an acrylic resin. In general, the adhesive is hardened to form an adhesion layer. Specific examples of the acrylic resin used for the adhesion layer include resins comprising structural units derived from an alkyl (meth)acrylate as a main component and those derived from a monomer having a polar functional group such as a free carboxyl group, a hydroxyl group, an amino group, or a heterocyclic group (e.g. an epoxy ring), and, preferably, a (meth)acrylic acid having a polar functional group. As used herein, (meth)acrylic acid may be either acrylic acid or methacrylic acid, and “(meth)” in (meth)acrylate and the like means analogously.

Examples of a (meth)acrylic acid ester include alkyl acrylates such as methyl acrylate, ethyl acrylate, propyl acrylate, butyl acrylate, isobutyl acrylate, 2-ethylhexyl acrylate, octyl acrylate, isooctyl acrylate, lauryl acrylate, stearyl acrylate, cyclohexyl acrylate, isobornyl acrylate, benzyl acrylate, methoxyethyl acrylate, and ethoxymethyl acrylate; and alkyl methacrylates such as methyl methacrylate, ethyl methacrylate, propyl methacrylate, butyl methacrylate, isobutyl methacrylate, 2-ethylhexyl methacrylate, octyl methacrylate, isooctyl methacrylate, lauryl methacrylate, stearyl methacrylate, cyclohexyl methacrylate, isobornyl methacrylate, benzyl methacrylate, methoxyethyl methacrylate, and ethoxymethyl methacrylate. These alkyl (meth)acrylates may be used alone or a copolymer of two or more of them may also be used.

These alkyl (meth)acrylates may be copolymerized with a (meth)acrylic acid ester having an alicyclic structure in a molecule. The alicyclic structure is in general a cycloparaffin structure having 5 or more carbon atoms, preferably about 5 to 7 carbon atoms. Specific examples of the acrylic acid ester having the alicyclic structure include isobornyl acrylate, cyclohexyl acrylate, dicyclopentanyl acrylate, cyclododecyl acrylate, methylcyclohexyl acrylate, trimethylcyclohexyl acrylate, tert-butyl cyclohexyl acrylate, cyclohexyl α-ethoxyacrylate, cyclohexylphenyl acrylate, and the like, and specific examples of the methacrylic acid ester having the alicyclic structure include isobornyl methacrylate, cyclohexyl methacrylate, dicyclopentanyl methacrylate, cyclododecyl methacrylate, methylcyclohexyl methacrylate, trimethylcyclohexyl methacrylate, tert-butyl cyclohexyl methacrylate, cyclohexylphenyl methacrylate, and the like.

Examples of the monomer having the polar functional group include a monomer having a free carboxyl group such as acrylic acid, methacrylic acid and β-carboxyethyl acrylate; a monomer having a hydroxyl group such as 2-hydroxyethyl (meth)acrylate, 2-hydroxypropyl (meth)acrylate, 2- or 3-chloro-2-hydroxypropyl (meth)acrylate and diethylene glycol mono(meth)acrylate; a monomer having a heterocyclic group such as acryloylmorpholine, vinylcaprolactam, N-vinyl-2-pyrrolidone, tetrahydrofurfuryl (meth)acrylate, caprolactone-modified tetrahydrofurfuryl acrylate, 3,4-epoxycyclohexylmethyl (meth)acrylate, glycidyl (meth)acrylate and 2,5-dihydrofuran; a monomer having an amino group different from the heterocyclic ring such as N,N-dimethylaminoethyl (meth)acrylate; and the like. These monomers having the polar functional group may be used alone, or two or more of the different monomers may also be used.

The acrylic resin to be used for the adhesion layer contains the structural units derived from the alkyl (meth)acrylate usually in an amount of 60 to 99.9 parts by weight, preferably 80 to 99.6 parts by weight, or the structural units derived from the monomer having the polar functional group usually in an amount of 0.1 to 20 parts by weight, preferably 0.4 to 10 parts by weight, based on 100 parts by weight of the nonvolatile content of the resin. When the (meth)acrylic acid ester having the alicyclic structure is copolymerized, the structural units derived therefrom are contained in an amount of about 0 to 10 parts by weight based on 100 parts by weight of the nonvolatile content of the acrylic resin.

The acrylic resin used in the present invention may optionally contain structural units derived from a monomer other than the above-described monomers having a (meth)acrylic acid ester including the alkylester and the monomers having the polar functional group.

Examples of such structural units include structural units derived from a styrene monomer, structural units derived from a vinyl monomer, structural units derived from a monomer having a plurality of (meth)acryloyl groups in a molecule, and the like.

More specifically, examples of the styrene monomer include styrene; alkylstyrene such as methylstyrene, dimethylstyrene, trimethylstyrene, ethylstyrene, diethylstyrene, triethylstyrene, propylstyrene, butylstyrene, hexylstyrene, heptylstyrene and octylstyrene; halogenated styrene such as fluorostyrene, chlorostyrene, bromostyrene, dibromostyrene and iodostyrene; nitrostyrene; acetylstyrene; methoxystyrene; divinylbenzene; and the like.

Examples of the vinyl monomer include aliphatic acid vinyl esters such as vinyl acetate, vinyl propionate, vinyl butyrate, vinyl 2-ethylhexanoate, or vinyl laurate; halogenated vinyl such as vinyl chloride or vinyl bromide; halogenated vinylidene such as vinylidene chloride; nitrogen-containing aromatic vinyl such as vinylpyridine, vinylpyrrolidone and vinylcarbazole; a conjugated diene monomer such as butadiene, isoprene, or chloroprene; acrylonitrile; methacrylonitrile; and the like.

Examples of the monomer having a plurality of (meth)acryloyl groups in a molecule include a monomer having two (meth)acryloyl groups in a molecule such as 1,4-butanediol di(meth)acrylate, 1,6-hexanediol di(meth)acrylate, 1,9-nonanediol di(meth)acrylate, ethylene glycol di(meth)acrylate, diethylene glycol di(meth)acrylate, tetraethylene glycol di(meth)acrylate and tripropylene glycol di(meth)acrylate; a monomer having three (meth)acryloyl groups in a molecule such as trimethylolpropane tri(meth)acrylate; and the like.

The monomers other than the (meth)acrylic acid ester and the monomers having the polar functional group may be used alone or in combination of two or more of them. In the acrylic resin to be used for the adhesion layer, the structural units derived from the monomer other than the (meth)acrylic acid ester and the monomers having the polar functional group is usually contained in an amount of 0 to 20 parts by weight, preferably 0 to 10 parts by weight, based on 100 parts by weight of a nonvolatile content of the resin.

An effective compound of the adhesion layer 11 may be one containing two or more of the above-described acrylic resins comprising the structural units derived from the alkyl (meth)acrylate as a main component and the structural units derived from the monomer having the polar functional group. Further, a mixture of the above-described acrylic resin with an acrylic resin different from the above-described acrylic resin, such as, for example, an acrylic resin having the structural units derived from the alkyl (meth)acrylate containing no polar functional group may be used.

The weight average molecular weight (Mw), in terms of standard polystyrene-converted molecular weight, measured by gel permeation chromatography (GPC) of the acrylic resin having the structural units derived from the alkyl (meth)acrylate as the main component and the structural units derived from the monomer having the polar functional group is preferably within a range of from 1,000,000 to 2,000,000. When the weight average molecular weight in terms of standard polystyrene-converted molecular weight is 1,000,000 or more, an adhesion property under a high temperature and a high humidity is improved, so that the possibility of the occurrence of warping and peeling between the glass substrate and the adhesion layer is desirably reduced, and the reworkability is desirably improved. When the weight average molecular weight is 2,000,000 or less, in the case where the dimension of the polarizing film bonded to the adhesion layer is changed, the adhesion layer changes following the dimensional change to eliminate a difference in brightness between the peripheral part and the central part of the liquid crystal cell, thereby suppressing white spots and color irregularity. A molecular weight distribution represented by a ratio (Mw/Mn) of the weight average molecular weight (Mw) to a number average molecular weight (Mn) is usually within a range of about 2 to 10.

A solution of the acrylic resin (or a mixture of acrylic resins in the case of using two or more acrylic resins) obtained by dissolving the acrylic resin(s) into ethyl acetate and adjusting a nonvolatile content concentration to 20 wt % preferably has a viscosity of 20 Pa·s or less, more preferably 0.1 to 7 Pa·s, at 25° C. When the viscosity is 20 Pa·s or less, the adhesion property under a high temperature and a high humidity is improved and thus the possibility of the occurrence of warping and peeling between the glass substrate and the adhesion layer is desirably reduced, and the reworkability is desirably improved. The viscosity can be measured with a Brookfield viscometer.

The acrylic resin constituting the adhesion layer may be produced by any of various known methods such as solution polymerization, emulsion polymerization, bulk polymerization, and suspension polymerization. In the production of an acrylic resin, a polymerization initiator is usually used. The polymerization initiator is used in an amount of about 0.001 to 5 parts by weight based on 100 parts by weight of all the monomers used for the acrylic resin production is.

As the polymerization initiator, a thermal polymerization initiator, a photopolymerization initiator, or the like may be used. Examples of the photopolymerization initiator include 4-(2-hydroxyethoxy)phenyl (2-hydroxy-2-propyl) ketone and the like. Examples of the thermal polymerization initiator include an azo compound such as 2,2′-azobisisobutyronitrile, 2,2′-azobis(2-methylbutyronitrile), 1,1′-azobis(cyclohexane-1-carbonitrile), 2,2′-azobis(2,4-dimethylvaleronitrile), 2,2′-azobis(2,4-dimethyl-4-methoxyvaleronitrile), dimethyl-2,2′-azobis(2-methylpropionate) and 2,2′-azobis(2-hydroxymethylpropionitrile); an organic peroxide such as lauryl peroxide, tert-butyl hydroperoxide, benzoyl peroxide, tert-butyl peroxybenzoate, cumen hydroperoxide, diisopropyl peroxydicarbonate, dipropyl peroxydicarbonate, tert-butyl peroxyneodecanoate, tert-butyl peroxypivalate and (3,5,5-trimethylhexanoyl) peroxide; an inorganic peroxide such as potassium persulfate, ammonium persulfate and hydrogen peroxide; and the like. Also, a redox initiator using a peroxide and a reducing agent may be used as a polymerization initiator.

As the acrylic resin production method, the solution polymerization is preferred among the above-described methods.

As a specific example of the solution polymerization, a method comprising mixing desired monomers and an organic solvent, adding a thermal polymerization initiator under a nitrogen atmosphere, and stirring the mixture preferably at about 60° C. to 80° C. for about 3 to 10 hours may be employed. Also, in order to control the reaction, the monomers and the thermal polymerization initiator may be added continuously or intermittently during the polymerization, or they may be added in the form of solutions in an organic solvent. Examples of the organic solvent include an aromatic hydrocarbon such as toluene and xylene; an ester such as ethyl acetate and butyl acetate; an aliphatic alcohol such as propyl alcohol and isopropyl alcohol; a ketone such as methyl ethyl ketone and methyl isobutyl ketone.

The adhesive is usually prepared by blending a crosslinking agent with the above-described acrylic resin. The crosslinking agent used herein is a compound having at least two functional groups crosslinkable with the polar functional group in a molecule, and specific examples thereof include an isocyanate compound, an epoxy compound, a metal chelate compound, an aziridine compound, and the like.

The isocyanate compound is a compound having at least two isocyanato groups (—NCO) in a molecule, and examples thereof include tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, naphthalene diisocyanate, triphenylmethane triisocyanate, and the like. Also, adducts obtained by reacting these isocyanate compounds with a polyol such as glycerol or trimethylolpropane or products obtained by changing the isocyanate compound to a dimmer, a trimer or the like can be a crosslinking agent to be used for the adhesion layer. Further, the mixtures of two or more isocyanate compounds may be used.

The epoxy compound is a compound having at least two epoxy groups in a molecule, and examples thereof include an epoxy resin of bisphenol A type, ethylene glycol diglycidyl ether, polyethylene glycol diglycidyl ether, glycerin diglycidyl ether, glycerin triglycidyl ether, 1,6-hexanediol diglycidyl ether, trimethylolpropane triglycidyl ether, N,N-diglycidylaniline, N,N,N′,N′-tetraglycidyl-m-xylenediamine, 1,3-bis(N,N′-diglycidyl aminomethyl)cyclohexane, and the like. The mixture of two or more epoxy compounds may be used.

Examples of the metal chelate compound include a compound obtained by coordinating acetylacetone or ethyl acetoacetate on a polyvalent metal such as aluminum, iron, copper, zinc, tin, titanium, nickel, antimony, magnesium, vanadium, chromium, or zirconium.

The aziridine compound is a compound having at least two three-membered ring skeletons comprising one nitrogen atom and two carbon atoms in a molecule, which is also called ethyleneimine, and examples thereof include diphenylmethane-4,4-bis(1-aziridinecarboxamide), toluene-2,4-bis(1-aziridinecarboxamide), triethylenemelamine, isophthaloyl bis-1-(2-methylaziridine), tris-1-aziridinyl phosphineoxide, hexamethylene-1,6-bis(1-aziridinecarboxamide), trimethylolpropane-tri-β-aziridinyl propionate, tetramethylolmethane-tri-β-aziridinyl propionnate, and the like.

Among the above crosslinking agents, the isocyanate compound is preferably used. Also, the combination of the isocyanate compound with the aziridine compound is effective. The crosslinking agent is usually contained in an amount of about 0.1 to 10 parts by weight, preferably about 0.1 to 7 parts by weight, based on 100 parts by weight of the nonvolatile content of the acrylic resin constituting the adhesive (a total amount in the case of using two or more resins). Since the amount of the crosslinking agent relates to a gel content described later, the amount may appropriately be selected from the above-specified ranges depending on the required gel content.

Preferably, a silane compound is blended with the adhesive in advance of blending with the crosslinking agent.

Examples of the silane compound include vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidoxypropyltrimethoxysilane, 3-glycidoxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methacryloyloxypropyltrimethoxysilane, 3-mercaptopropyltrimethoxysilane, phenyltrimethoxysilane, hexyltrimethoxysilane, hexamethylsilazane, decyltrimethoxysilane, diphenyldimethoxysilane, 1,3,5-tris(3-trimethoxysilylpropyl)isocyanurate, and the like. It is possible to use two or more types of the silane compounds.

A polymeric or oligomeric silane compound may be used as the silane compound. Examples of the polymeric and oligomeric silane compound include the following:

A copolymer containing a mercaptopropyl group such as 3-mercaptopropyltrimethoxysilane-tetramethoxysilane copolymer, 3-mercaptopropyltrimethoxysilane-tetraethoxysilane copolymer, 3-mercaptopropyltriethoxysilane-tetramethoxysilane copolymer and 3-mercaptopropyltriethoxysilane-tetraethoxysilane copolymer; a copolymer containing a mercaptomethyl group such as mercaptomethyltrimethoxysilane-tetramethoxysilane copolymer, mercaptomethyltrimethoxysilane-tetraethoxysilane copolymer, mercaptomethyltriethoxysilane-tetramethoxysilane copolymer and mercaptomethyltriethoxysilane-tetraethoxysilane copolymer; a copolymer containing a methacryloyloxypropyl group such as 3-methacryloyloxypropyltrimethoxysilane-tetramethoxysilane copolymer, 3-methacryloyloxypropyltrimethoxysilane-tetraethoxysilane copolymer, 3-methacryloyloxypropyltriethoxysilane-tetramethoxysilane copolymer, 3-methacryloyloxypropyltriethoxysilane-tetraethoxysilane copolymer, 3-methacryloyloxypropylmethyldimethoxysilane-tetramethoxysilane copolymer, 3-methacryloyloxypropylmethyldimethoxysilane-tetraethoxysilane copolymer, 3-methacryloyloxypropylmethyldiethoxysilane-tetramethoxysilane copolymer and 3-methacryloyloxypropylmethyldiethoxysilane-tetraethoxysilane copolymer; a copolymer containing an acryloyloxypropyl group such as 3-acryloyloxypropyltrimethoxysilane-tetramethoxysilane copolymer, 3-acryloyloxypropyltrimethoxysilane-tetraethoxysilane copolymer, 3-acryloyloxypropyltriethoxysilane-tetramethoxysilane copolymer, 3-acryloyloxypropyltriethoxysilane-tetraethoxysilane copolymer, 3-acryloyloxypropylmethyldimethoxysilane-tetramethoxysilane copolymer, 3-acryloyloxypropylmethyldimethoxysilane-tetraethoxysilane copolymer, 3-acryloyloxypropylmethyldiethoxysilane-tetramethoxysilane copolymer and 3-acryloyloxypropylmethyldiethoxysilane-tetraethoxysilane copolymer; a copolymer containing a vinyl group such as vinyltrimethoxysilane-tetramethoxysilane copolymer, vinyltrimethoxysilane-tetraethoxysilane copolymer, vinyltriethoxysilane-tetramethoxysilane copolymer, vinyltriethoxysilane-tetraethoxysilane copolymer, vinylmethyldimethoxysilane-tetramethoxysilane copolymer, vinylmethyldimethoxysilane-tetraethoxysilane copolymer, vinylmethyldiethoxysilane-tetramethoxysilane copolymer and vinylmethyldiethoxysilane-tetraethoxysilane copolymer; a copolymer containing an amino group such as 3-aminopropyltrimethoxysilane-tetramethoxysilane copolymer, 3-aminopropyltrimethoxysilane-tetraethoxysilane copolymer, 3-aminopropyltriethoxysilane-tetramethoxysilane copolymer, 3-aminopropyltriethoxysilane-tetraethoxysilane copolymer, 3-aminopropylmethyldimethoxysilane-tetramethoxysilane copolymer, 3-aminopropylmethyldimethoxysilane-tetraethoxysilane copolymer, 3-aminopropylmethyldiethoxysilane-tetramethoxysilane copolymer and 3-aminopropylmethyldiethoxysilane-tetraethoxysilane copolymer; and the like.

Many of these silane compounds are liquid compounds. The content of the silane compound in the adhesive is usually about 0.0001 to 10 parts by weight, preferably 0.01 to 5 parts by weight, based on 100 parts by weight (a total amount in the case of using two or more resins) of the nonvolatile content of the acrylic resin. When the amount of the silane compound is 0.0001 parts by weight or more based on 100 parts by weight of the nonvolatile content of the acrylic resin, adhesion between the adhesion layer and the glass substrate is desirably improved. When the amount is 10 parts by weight or less, bleed-out of the silane compound from the adhesion layer tends to be desirably suppressed.

The above-described adhesive may further contain a crosslinking catalyst, a weathering stabilizer, a tackifier, a plasticizer, a softener, a dye, a pigment, an inorganic filler, and the like. In particular, when the crosslinking catalyst is blended in the adhesive together with the crosslinking agent, the adhesion layer can be prepared by aging in a short time, the occurrence of warping and peeling between the adhesion layer and the polarizing film and generation of foaming in the adhesion layer in the optical laminate to be obtained can be suppressed, and the reworkability can be further improved. Examples of the crosslinking catalyst include an amine compound such as hexamethylenediamine, ethylenediamine, polyethyleneimine, hexamethylenetetramine, diethylenetriamine, triethylenetetramine, isophoronediamine, trimethylenediamine, a polyamino resin, or a melamine resin. When the amine compound is added as the crosslinking catalyst to the adhesive, the isocyanate compound is preferably used as the crosslinking agent.

In the present invention, the adhesion layer 11 has a gel content of 75 to 95 wt % as described above. Herein, the gel content is a value measured in accordance with the following steps (I) to (IV):

(I) An adhesion layer having an area of about 8 cm×about 8 cm and a metal mesh (having a weight of Wm) formed of SUS 304 having a size of about 10 cm×about 10 cm are bonded to each other.

(II) The weight of the bonded body obtained in step (I) is weighed to obtain a weight Ws, and the bonded body is folded four times in such a way as to enclose the adhesion layer and stapled, followed by weighing to obtain a weight Wb.

(III) The mesh which is stapled in step (II) is placed in a glass container, and 60 mL of ethyl acetate is added thereto, followed by immersion. The glass container is stored at room temperature for 3 days.

(IV) The mesh is taken out of the glass container and dried at 120° C. for 24 hours, followed by weighing to obtain a weight Wa. The gel content is calculated according to the following equation:

Gel content (wt %)=[{Wa−(Wb−Ws)−Wm}/(Ws−Wm)]×100

The gel content of the adhesion layer 11 is set to 75 to 95 wt %. A gel content of 75 wt % or more is preferred since such a content tends to suppress the occurrence of warping and peeling between the adhesion layer 11 and the amorphous cyclic polyolefin resin film 12 forming the polarizing film 15 as well as the generation of foaming in the adhesion layer. A gel content of 95 wt % or less is preferred because of easy production of the adhesive.

To adjust the gel content of the adhesion layer 11 in a range of 75 to 95 wt %, the gel content can be adjusted by selecting an amount of the crosslinking agent since the gel content is increased by increasing the amount of the crosslinking agent although depending on the type of the acrylic resin which is the effective ingredient in the adhesion layer. More specifically, a content of the crosslinking agent may be appropriately selected from a range of about 0.3 to 7 parts by weight based on 100 parts by weight of the nonvolatile content of the acrylic resin constituting the adhesion layer 11 (the total amount of the acrylic resins in the case of using two or more types of acrylic resins), depending on the type of the acrylic resin.

The thickness of the adhesion layer 11 is not particularly limited and is preferably 30 μm or less and 10 μm or more. An adhesion layer thickness of 30 μm or less is preferred since such a thickness makes it possible to improve the adhesion property under a high temperature and a high humidity, to reduce the possibility of the occurrence of warping and peeling between the glass substrate and adhesion layer and to improve the reworkability. A thickness of 10 μm or more is preferred since, when the dimension of the polarizing film bonded thereto is changed, such a thickness allows the adhesion layer to change along with the dimensional change, thereby making it possible to eliminate a difference in luminance between the peripheral part and the central part of the liquid crystal cell, resulting in suppression of white spots and color irregularity.

In general, the standard of the thickness of the adhesion layer to be bonded to the liquid crystal display glass cell is heretofore considered to be about 25 μm, but it is advantageous to maintain the thickness of the adhesion layer 11 formed on the amorphous cyclic polyolefin resin film 12 in the present invention at 20 μm or less. In general, when the adhesion layer is made thick, foaming tends to occur easily while the white spots are easily suppressed. When the adhesion layer is made thin, foaming is suppressed while the white spots easily appear. In the present invention, the amorphous cyclic polyolefin resin film 12 to be used for the polarizing film 15 has the small phase difference change caused by a temperature change or the like because of the small photoelastic coefficient as described above. Therefore, white spots attributed to the adhesion layer hardly appear when the adhesion layer 11 to be provided on the film 12 is made thin. Also, if a dimensional change occurs in the polarizing film 15 or the amorphous cyclic polyolefin resin film 12 forming the polarizing film 15, the influence of the dimensional change on the adhesion layer is small when the adhesion layer 11 is thin. Therefore, the white spots hardly appear even when the thickness of the adhesion layer 11 is reduced to 20 μm or less, and it is possible to contribute to the thinning of the overall optical laminate which is obtained by bonding the adhesion layer to the liquid crystal display glass cell.

In the polarizing film with the adhesive of the present invention, a brightness-improving film 17 may be laminated on the outer side of the protection film 14 forming the polarizing film 15 as shown in FIG. 2.

Since parts in FIG. 2 other than the brightness-improving film 17 disposed on the outer side (a side opposite to the adhesion layer 11) of the protection film 14 are the same as those in FIG. 1, the same parts are denoted by the same reference numerals as those in FIG. 1 and the detailed descriptions thereof are omitted.

As used herein, the brightness-improving film 17 is an optical film capable of enhancing a use efficiency of backlight in a liquid crystal display device. Examples of the brightness-improving film include “DBEF” which is a reflection type polarization split film available from 3M Company of USA (available from Sumitomo 3M Limited in Japan), “BEF” which is an upward prism sheet also available from 3M Company, “DiaArt” which is a downward prism sheet available from Mitsubishi Rayon Co., Ltd., and the like.

[Production Method for Polarizing Film with Adhesive]

The polarizing film with the adhesive of the present invention as described above may be produced by a method comprising providing the polarizing film 15 having the structure of amorphous cyclic polyolefin resin film 12/polarizer 13/protection film 14; separately providing the adhesive the gel content of which is adjusted to 75 to 95 wt %; and applying the adhesive to the surface of the amorphous cyclic polyolefin resin film 12 of the polarizing film 15 to form the adhesion layer 11. As shown in FIG. 2, in the case of applying the brightness-improving film 17 on the outer side of the protection film 14, the brightness-improving film 17 is advantageously bonded to the outer side of the protection film 14 with interposing an adhesive and the like when the polarizing film 15 having the structure of amorphous cyclic polyolefin resin film 12/polarizer 13/protection film 14 is provided.

When forming the adhesion layer 11 on the surface of the amorphous cyclic polyolefin resin film 12, a method comprising directly applying an organic solvent solution of the adhesive the gel content of which is adjusted to 75 to 95 wt %, followed by drying may be employed. Alternatively, it is possible to employ a method comprising forming the adhesion layer 11 the gel content of which is adjusted to 75 to 95 wt % on a release film and transferring the adhesion layer 11 to the surface of the amorphous cyclic polyolefin resin film 12.

In the latter case, the adhesion layer 11 is formed by applying the solution of the adhesive which is diluted with an organic solvent to the release film and eliminating the organic solvent by heating at a temperature of 60° C. to 120° C. for about 0.5 to 10 minutes.

Subsequently, the polarizing film 15 having the structure of amorphous cyclic polyolefin resin film 12/polarizer 13/protection film 14 is bonded to the adhesion layer at the side of the amorphous cyclic polyolefin resin film 12, and then the crosslinking agent is sufficiently reacted by aging under an atmosphere of room temperature (about 23° C.) and a relative humidity of about 65% for about 5 to 20 days. Thereafter, the release film is peeled off to obtain the laminate of the adhesion layer 11 and the polarizing film 15.

Also, the following method can be exemplified as another method of transferring the adhesion layer formed on the release film to the surface of the amorphous cyclic polyolefin resin film 12. That is, a laminate having two layers, which are the release film and the adhesion layer, is obtained. In a state where the laminate is rolled up, the crosslinking agent is allowed to sufficiently react by aging under an atmosphere of room temperature (about 23° C.) and a relative humidity of about 65% for about 5 to 20 days. When the laminate is rolled up, a release film whose both surfaces are subjected to a release treatment may be used, and the adhesion layer may be sandwiched between the release films, or another release film may be bonded to an exposed surface of the adhesion layer. After completing the aging, one surface of the adhesion layer is exposed with leaving the release film on the surface, and the side of the amorphous cyclic polyolefin resin film 12 of the polarizing film 15 is bonded to the exposed surface, to obtain the polarizing film with the adhesion layer 10.

Here, the release film serves as a base material for forming the adhesion layer. The release film may take a role of protecting the adhesion layer from contaminants such as dust during the aging and the storage of the laminate of the adhesion layer and the polarizing film. Specific examples of the release film include those obtained by using, as a base material, a film made from a resin such as polyethyleneterephthalate, polybutyleneterephthalate, polycarbonate, or polyarylate and performing a release treatment such as a silicone treatment on a bonding surface between the base material and the adhesion layer.

When the adhesion layer 11 is formed on the surface of the amorphous cyclic polyolefin resin film 12 of the polarizing film 15 having the structure of amorphous cyclic polyolefin resin film 12/polarizer 13/protection film 14, a corona discharge treatment is preferably performed on the bonding surface of the amorphous cyclic polyolefin resin film 12 in order to enhance an adhesion force with the adhesion layer 11. The corona discharge treatment is a treatment for activating a resin film disposed between electrodes by applying a high voltage between the electrodes. The corona discharge treatment is preferably performed by setting an output power to about 200 to 1,000 W. When the output power of the corona discharge treatment is set to 200 W or more, the effect of the treatment becomes prominent to improve the adhesion force between the adhesion layer 11 and the amorphous cyclic polyolefin resin film 12. Also, by setting the output power of the corona discharge treatment to 1,000 W or less, it is possible to reduce dust which tends to be caused by the treatment. The effect of the corona discharge treatment varies with the type of the electrode, an electrode distance, a voltage, a humidity, and the type of the resin film to be used, and it is preferable to set the electrode distance to about 1 to 5 mm and a transfer rate to about 3 to 20 m/min.

### [Optical Laminate]

An optical laminate for liquid crystal display can be produced by bonding the polarizing film 10 with the adhesive described above to a liquid crystal display glass cell at the side of the adhesion layer 11. Although the polarizing film may be bonded to the other surface of the liquid crystal display glass cell with interposing an adhesion layer same as the above-described adhesion layer 11, preferably the polarizing film having the structure, in which the acetylcellulose-based protection films are bonded to the both surfaces of the polarizer, is bonded with interposing an adhesion layer having a gel content lower than that of the adhesion layer 11 on the opposite side, in order to suppress optical defects such as white spots. The mode of bonding the polarizing films to the both surfaces of the liquid crystal display glass cell with interposing the adhesion layers having different gel contents will hereinafter sometimes referred to as the “first embodiment of the optical laminate”.

When the polarizing films having the structure of amorphous cyclic polyolefin resin film/polarizer/protection film is bonded to the both surfaces of a liquid crystal display glass cell at the sides of the amorphous cyclic polyolefin resin films, preferably the respective polarizing films are bonded with interposing the adhesion layers having a high gel content and a large aggregation force as described above. As described above, the mode of bonding the polarizing films having the structure of amorphous cyclic polyolefin resin film/polarizer/protection film to the both surfaces of a liquid crystal display glass cell at the sides of the amorphous cyclic polyolefin resin films with interposing the adhesion layers having a high gel content will hereinafter be sometimes referred to as the “second embodiment of the optical laminate”.

In either modes, as shown in FIG. 3, an optical laminate 30 according to the present invention has the structure of bonding the first polarizing film 15 to one surface of a liquid crystal display cell 35 with interposing the first adhesion layer 11 and bonding the second polarizing film 25 to the other surface of the glass cell 35 with interposing the second adhesion layer 21. The first polarizing film 15 has the structure of amorphous cyclic polyolefin resin film 12/polarizer 13/protection film 14, and the first adhesion layer 11 has a gel content of 75 to 95 wt %, so that the first polarizing film 15 is bonded to one surface of the liquid crystal display glass cell 35 with interposing the first adhesion layer 11 at the side of the amorphous cyclic polyolefin resin film 12.

In the optical laminate 30, though it is possible to arbitrarily select one of the first polarizing film 15 and the second polarizing film 25 to be used as the front side (visible side) or the rear side (backlight side), it is preferable to use the first polarizing film 15 having the amorphous cyclic polyolefin resin film 12 as the rear side. In this case, a surface treatment layer 27 is preferably provided on the outer side of a protection film 24 at the opposite side of the adhesion layer 21 of the second polarizing film 25 used for the front side as shown in FIG. 4, and it is possible to laminate the same brightness-improving film 17 as that described with reference to FIG. 2 on the outer side of the protection film 14 in the first polarizing film 15 used as the rear side. Since the polarizing film 10 with the adhesive in FIG. 3 disposed on one surface of the liquid crystal display glass cell 35 (the lower part of the drawing) is the same as that shown in FIG. 1, and since the polarizing film 10 with the adhesive in FIG. 4 disposed on one surface of the liquid crystal display glass cell 35 (the lower part of the drawing) is the same as that shown in FIG. 2, these are denoted by the same reference numerals as those in FIGS. 1 and 2, respectively and the detailed descriptions thereof are omitted.

The liquid crystal display glass cell 35 comprises glass substrates, and one obtained by filling a liquid crystal compound between a pair of glass substrates is usually used for a liquid crystal display device. A liquid crystal display mode in the liquid crystal display glass cell 35 may be various types that are known in the art such as TN, STN, IPS (In-Plane Switching), VA (Vertical Alignment), and OCB (Optically Compensated Birefringence). Examples of a material for the glass substrate include soda lime glass, low alkali glass, alkali-free glass, and the like.

The surface treatment layer 27 optionally provided on the outer side of the second polarizing film 25 may be used to increase display characteristics and surface physical properties by suppressing the reflection of a light beam emitted from an external light source such as a fluorescent lamp and enhancing the visibility of the liquid crystal display device. Specific examples of the surface treatment layer 27 include an antiglare (AG) layer for scattering reflected light by means of unevenness formed on a surface, an anti-reflection (AR) layer utilizing interference of light, a low reflection (LR) layer suppressing a reflectance with a coating film, and the like. In the case where a hard coat layer is directly provided on the surface of the polarizing film or in the case where a hard coat layer is provided on the antiglare layer, the anti-reflection layer, the low reflection layer, or the like, the hard coat layer also can serve as the surface treatment layer 27.

The first polarizing film 15 and the second polarizing film 25 are usually bonded to the respective surfaces of the liquid crystal display glass cell 35 with interposing the adhesion layers in such a manner that transmission axes form a predetermined angle, i.e. the transmission axes are orthogonal in the case of the TN mode, the IPS mode, or the VA mode, for example.

The second adhesion layer 21 used for bonding the second polarizing film 25 and the liquid crystal display glass cell 35 may be one formed by hardening an adhesive obtained by blending an acrylic resin with a crosslinking agent in the same manner as in the first adhesion layer 11 described with reference to FIG. 1. The description of the first adhesive is applicable to Acrylic Resin And the crosslinking agent. Also, it is preferable to blend the silane compound with the adhesive forming the second adhesion layer 21 in the same manner as in the first adhesion layer.

### First Embodiment of Optical Laminate

The first embodiment of the optical laminate will be described with reference to FIG. 3 mainly and also to FIG. 4 if necessary. In this mode, it is preferable to: bond the first polarizing film 15 having the structure of amorphous cyclic polyolefin resin film 12/polarizer 13/protection film 14 to one surface of the liquid crystal display glass cell 35 with interposing the first adhesion layer 11 having a gel content of 75 to 95 wt % which is provided on the side of the amorphous cyclic polyolefin resin film 12; bond the second polarizing film 25 in which acetylcellulose-based protection films 22 and 24 are bonded to the both surfaces of the polarizer 23 to the other surface of the liquid crystal display glass cell 35 with interposing the second adhesion layer 21; and maintain the gel content of the second adhesion layer 21 at 30 to 70 wt %.

In this mode, though it is possible to arbitrarily select one of the first polarizing film 15 and the second polarizing film 25 to be used as the front side (visible side) or the rear side (backlight side), it is preferable to use the second polarizing film 25 having the structure in which the acetylcellulose-based protection films 22 and 24 are bonded to both sides of the polarizer 23 for the front side. In this case, as shown in FIG. 4, the surface treatment layer 27 is preferably provided on the outer side of the protection film 24 at the opposite side of the adhesion layer 21 of the second polarizing film 25 used as the front side, and it is possible to laminate the same brightness-improving film 17 as that described with reference to FIG. 2 on the outer side of the protection film 14 in the first polarizing film 15 used as the rear side.

Hereinafter, the second polarizing film 25 will be described. The polarizing film is an optical film having a function of beaming polarized light for incident light such as natural light. The polarizing film include a linear polarizing film having a property of absorbing linear polarized light having a vibration plane in one direction and transmitting linear polarized light having a vibration plane orthogonal to the above-mentioned vibration plane, an elliptic polarizing film obtained by laminating a phase difference film on a linear polarizing film, and the like. As the second polarizing film 25, those having the linear polarizing film are preferably used. Specific examples of the polarizer 23 forming the second polarizing film 25 include a polarizer formed of a uniaxially drawn polyvinyl alcohol resin film and a dichromatic pigment such as iodine or a dichromatic dye oriented on the film by adsorption in the same manner as in the polarizer 13 forming the first polarizing film 15.

The polarizer 23 has the acetylcellulose-based protection films 22 and 24 bonded to the respective surfaces thereof. Specific examples of the acetylcellulose protection film include a triacetylcellulose film and a diacetylcellulose film, among which the triacetylcellulose film is preferably used. The thickness of the protection films 22 and 24 usually is about 30 to 120 μm.

In the first embodiment of the optical laminate, the second adhesion layer 21 preferably has a gel content of 30 to 70 wt %, more preferably 40 wt % or more and 65 wt % or less. The gel content can be measured by the method described above in connection with the first adhesive. A gel content of 30 wt % or more of the second adhesion layer 21 is preferred since such a gel content makes it possible to improve the adhesion property under a high temperature and a high humidity, to reduce the possibility of the occurrence of warping and peeling between the glass substrate and the adhesion layer, and to improve the reworkability. A gel content of 70 wt % or less is preferred since, if the dimension of the second polarizing film 25 bonded to the adhesion layer changes, such a gel content allows the adhesion layer to change along with the dimensional change, thereby making it possible to eliminate a difference in luminance between the peripheral part and the central part of the liquid crystal cell, resulting in the tendency of suppressing white spots and color irregularity.

The perform gel content of the second adhesion layer 21 can be adjusted by selecting the content of the crosslinking agent in the adhesive. Since the amount of the crosslinking agent which enables the gel content of the second adhesion layer 21 of 30 to 70 wt % differs depending on the type of Acrylic Resin And the like, the content of the crosslinking agent may appropriately be selected depending on the type(s) of the acrylic resin(s) from a range of about 0.1 to 3 parts by weight based on 100 parts by weight of the nonvolatile content of the acrylic resin (a total amount of the acrylic resins in the case of using two or more types of acrylic resins) forming the second adhesion layer 21.

According to a preferred definition in the first embodiment of the optical laminate, the gel content of the first adhesion layer 11 is larger than the gel content of the second adhesion layer 21 by at least 5 wt %, but it is further preferable to keep the difference between the gel contents to 10 wt % or more, more preferably 15 wt % or more.

In the second adhesion layer 21 forming the first embodiment of the optical laminate, it is effective to use the acrylic resin (first acrylic resin) comprising the structural units derived from an alkyl (meth)acrylate as a main component and the structural units derived from the monomer having the polar functional group, particularly, the acrylic resin having the weight average molecular weight (Mw) of 1,000,000 to 2,000,000 described for the first adhesion layer 11 in combination with the second acrylic resin different from the acrylic resin. In this case, the second acrylic resin preferably has the structural units derived from an alkyl (meth)acrylate as a main component and preferably has a weight average molecular weight (Mw) in terms of standard polystyrene-converted molecular weight by GPC within a range of from 50,000 to 500,000. The weight average molecular weight of 50,000 or more is preferred since such a weight average molecular weight makes it possible to improve the adhesion property under a high temperature and a high humidity, to reduce the possibility of the occurrence of warping and peeling between the glass substrate and the adhesion layer, and to improve the reworkability. The weight average molecular weight of 500,000 or less is preferred since, when the dimension of the second polarizing film 25 bonded to the adhesion layer changes, such a gel content allows the adhesion layer to change along with the dimensional change, thereby making it possible to eliminate the difference in luminance between the peripheral part and the central part of the liquid crystal cell, resulting in suppression of white spots and color irregularity.

When the mixture of the first acrylic resin and the second acrylic resin is used, an amount of the second acrylic resin is preferably 5 to 50 parts by weight, more preferably about 20 to 40 wt %, based on 100 parts of a total of the acrylic resins. An amount of the second acrylic resin of 5 parts by weight or more based on 100 parts by weight of the total of the acrylic resins is preferred since, when the dimension of the second polarizing film 25 bonded to the adhesion layer changes, such an amount allows the adhesion layer to change along with the dimensional change, thereby making it possible to eliminate a difference in luminance between the peripheral part and the central part of the liquid crystal cell, resulting in suppression of white spots and color irregularity, and the second acrylic resin amount of 50 parts by weight or less is preferred since such an amount makes it possible to improve the adhesion property under a high temperature and a high humidity, to reduce the possibility of the occurrence of warping and peeling between the glass substrate and the adhesion layer, and to improve the reworkability.

The thickness of the second adhesion layer 21 is not particularly limited, but it is preferably 30 μm or less and 10 μm or more. The thickness of the adhesion layer of 30 μm or less is preferred since such a thickness makes it possible to improve the adhesion property under a high temperature and a high humidity, to reduce the possibility of the occurrence of warping and peeling between the glass substrate and the adhesion layer, and to improve the reworkability, and the thickness of 10 μm or more is preferred since, when the dimension of the polarizing film bonded to the adhesion layer changes, such a thickness allows the adhesion layer to change along with the dimensional change, thereby making it possible to eliminate the difference in luminance between the peripheral part and the central part of the liquid crystal cell, resulting in suppression of white spots and color irregularity. The thickness of the second adhesion layer 21 is more preferably 25 μm or less and 15 μm or more.

### Second Embodiment of Optical Laminate

Hereinafter, the second embodiment of the optical laminate will be described with reference to FIG. 3 mainly and also to FIG. 4 if necessary. In this embodiment, the first polarizing film 15 having the structure of amorphous cyclic polyolefin resin film 12/polarizer 13/protection film 14 is laminated on one surface of the liquid crystal display glass cell 35 with interposing the first adhesion layer 11 having A gel content of 75 to 95 wt % provided on the side of the amorphous cyclic polyolefin resin film 12, and the second polarizing film 25 having the structure of amorphous cyclic polyolefin resin film 22/polarizer 23/protection film 24 is laminated on the other surface of the liquid crystal display glass cell 35 with interposing the second adhesion layer 21 having A gel content of 75 to 95 wt % provided on the side of the amorphous cyclic polyolefin resin film 22.

The description given above for the polarizing film 15 with reference to FIG. 1 is applicable to the second polarizing film 25 in this mode. Also, the description given above for the adhesion layer 11 with reference to FIG. 1 is applicable to the second adhesion layer 21.

In this optical laminate, since the surfaces of the liquid crystal display glass cell 35 have a basically symmetrical structure, it is possible to use either one of the surfaces as the front side (visible side) or the rear side (backlight side). In FIG. 4, the second polarizing film 25 is used as the front side. The surface treatment layer 27 is preferably provided on the outer side of the protection film 24 which is on the opposite side of the adhesion layer 21 in the second polarizing film 25 serving as the front side. Also, the brightness-improving film 17 can be laminated on the outer side of the protection film 14 in the first polarizing film 15 serving as the rear side.

### [Production Method for Optical Laminate]

The optical laminate shown in FIG. 3 can be produced by a method comprising bonding the first polarizing film 15 having the structure of amorphous cyclic polyolefin resin film 12/polarizer 13/protection film 14 to one surface of the liquid crystal display glass cell 35 with interposing the first adhesion layer 11 at the side of the amorphous cyclic polyolefin resin film 12, and bonding the second polarizing film 25 to the other surface of the liquid crystal display glass cell 35 with interposing the second adhesion layer 21.

In the production of the first embodiment of the optical laminate described above, it is possible to employ a method comprising applying the first adhesion layer 11 having the gel content adjusted to 75 to 95 wt % to the surface of the amorphous cyclic polyolefin resin film 12 of the first polarizing film 15; applying the second adhesion layer 21 having the gel content adjusted to 30 to 70 wt % on one surface of the second polarizing film 25; and bonding the first polarizing film 15 and the second polarizing film 25 to both of the surfaces of the liquid crystal display glass cell 35 with interposing the adhesion layers. As shown in FIG. 4, in the case of applying the brightness-improving film 17 on the outer side of the protection film 14 of the first polarizing film 15, advantageously the brightness-improving film 17 is bonded to the outer side of the protection film 14 with interposing an adhesive or the like, when the first polarizing film 15 having the structure of amorphous cyclic polyolefin resin film 12/polarizer 13/protection film 14 is provided. In the case of applying the surface treatment layer 27 on one surface of the second polarizing film 25, it is possible to employ a method comprising forming the second polarizing film 25 in a state where the surface treatment layer 27 is provided on one surface of the protection film 24 and bonding the second polarizing film 25 to one surface of the liquid crystal display glass cell 35 with interposing the second adhesion layer 21, or it is possible to employ a method comprising forming the optical laminate and finally bonding the film on which the surface treatment layer 27 is formed to the surface of the second polarizing film 25, but the former method is generally advantageous.

More specifically, the optical laminate of the first embodiment can be produced by the following method. The first adhesion layer 11 is formed on the surface of the amorphous cyclic polyolefin resin film 12 of the first polarizing film 15 (on which the brightness-improving film 17 is applied to the outer side of the protection film 14 if necessary) having the structure of amorphous cyclic polyolefin resin film 12/polarizer 13/protection film 14, in accordance with the method described above in connection with the production method of the polarizing film with an adhesive to obtain the first polarizing film 10 with the adhesive. Separately, the second adhesion layer 21 is formed on the second polarizing film 25 on the surface of the protection film 22 (the opposite surface of the surface treatment layer 27 when the second polarizing film 25 has the surface treatment layer 27) in accordance with the above-described method, to obtain the second polarizing film 20 with the adhesive. The first polarizing film 10 with the adhesive and the second polarizing film 20 with the adhesive are bonded to the surfaces of the liquid crystal display glass cell 35 at the adhesion layer sides.

Alternatively, the following method may be employed. The first adhesion layer 11 is formed on a release film in accordance with the above-described method, and the second adhesion layer 21 is formed on another release film. The first adhesion layer 11 is transferred on the amorphous cyclic polyolefin resin film 12 of the first polarizing film 15, and the second adhesion layer is transferred on the second polarizing film 25. Thereafter, the release films are peeled off to obtain the laminate of the first adhesion layer 11 and the first polarizing film 15, and the laminate of the second adhesion layer 21 and the second polarizing film 25. The first adhesion layer 11 is laminated on one surface of the liquid crystal display glass cell 35, and the second adhesion layer 21 is laminated on the other surface of the liquid crystal display glass cell 35, followed by laminating the surface treatment layer 27 on the surface of the second polarizing film 25.

In this case, for example, a film on which the surface treatment layer 27 is formed is provided, and then the film is bonded to the surface of the second polarizing film 25.

The optical laminate of the second embodiment can be produced by the above-described method except using a polarizing film having the structure of amorphous cyclic polyolefin resin film 22/polarizer 23/protection film 24 as the second polarizing film 25; using an adhesion layer having a gel content of 75 to 95 wt % as the second adhesion layer 21.

### [Set of Polarizing Films]

The set of polarizing films according to the present invention comprises the first polarizing film 10 with the adhesive having the first polarizing film 15 having the structure of amorphous cyclic polyolefin resin film 12/polarizer 13/protection film 14 described above as the first embodiment of the optical laminate with reference to FIG. 3 and the first adhesion layer 11 provided on the side of the amorphous cyclic polyolefin resin film 12 and the second polarizing film 20 with the adhesive having the second polarizing film 25 in which the acetylcellulose-based protection films 22 and 24 are bonded to the respective surfaces of the polarizer 23 and the second adhesion layer 21 provided on one surface of the second polarizing film 25. The first adhesion layer 11 has a gel content of 75 to 95 wt %, and the second adhesion layer 21 has a gel content of 30 to 70 wt %.

### [Production Method for Set of Polarizing Films]

The set of polarizing films can be produced specifically by a method comprising forming the first polarizing film 10 with the adhesive by providing the first adhesion layer 11 on the side of the amorphous cyclic polyolefin resin film 12 of the first polarizing film 15 having the structure of amorphous cyclic polyolefin resin film 12/polarizer 13/protection film 14; and separately forming the second polarizing film 20 with the adhesive by providing the second adhesion layer on one surface of the second polarizing film 25 in which the acetylcellulose-based protection films 22 and 24 are bonded to the respective surfaces of the polarizer 22. As shown in FIG. 4, when the brightness-improving film 17 is applied to the side of the first polarizing film 15, it is advantageous to bond the brightness-improving film 17 to the outer side of the protection film 14 with interposing an adhesive or the like when the first polarizing film 15 having the structure of amorphous cyclic polyolefin resin film 12/polarizer 13/protection film 14 is provided. When the surface treatment layer 27 is provided on one surface of the second polarizing film 25, it is advantageous to form the second polarizing film 25 in a state where the surface treatment layer 27 is provided on one surface of the protection film 24. The first adhesion layer 11 is prepared to have the gel content adjusted to 75 to 95 wt % and provided on the surface of the amorphous cyclic polyolefin resin film 12 of the first polarizing film 15, and the second adhesion layer 21 is prepared to have the gel content adjusted to 30 to 70 wt % and provided on one surface of the second polarizing film 25 (on the opposite side of the surface treatment layer 27 when the second polarizing film 25 has the surface treatment layer 27).

Each of the adhesion layers may be formed on the surface of the amorphous cyclic polyolefin resin film 12 of the first polarizing film 15 or one surface of the second polarizing film 25 by a method of directly applying a solution of the adhesive. However, as described above as examples of the production method for the polarizing film with an adhesive and the production method of the optical laminate, advantageously the adhesion layers are formed by the method comprising applying the solutions of the adhesives on release films; removing the solvent; and providing the adhesion layers on the polarizing film surfaces by transfer. In the latter case, the first adhesion layer 11 is adjusted to have a gel content of 75 to 95 wt %, and the adhesive diluted with an organic solvent is applied on the release film, followed by bonding to the surface of the amorphous cyclic polyolefin resin film 12 of the first polarizing film 15 after the organic solvent is removed. The second adhesion layer 21 is prepared to have A gel content of 30 to 70 wt %, and the adhesive diluted with an organic solvent is applied on the release film, followed by bonding to one surface of the second polarizing film 25 after the organic solvent is removed.

In either case, the adhesion layer is aged for a sufficient period of time for reacting the crosslinking agent before or after being bonded to the polarizing film.

As described as the second embodiment of the optical laminate, the combination of the first polarizing film 10 with the adhesive having the polarizing film 15 having the structure of amorphous cyclic polyolefin resin film 12/polarizer 13/protection film 14 and the first adhesion layer 11 provided on the side of the amorphous cyclic polyolefin resin film 12 and the second polarizing film 20 with the adhesive having the second polarizing film 25 having the structure of amorphous cyclic polyolefin resin film 22/polarizer 23/protection film 24 and the second adhesion layer 21 provided on one surface of the second polarizing film 25 may be another set of polarizing films. Since the two polarizing films with the adhesives 10 and 20 basically have the same structure except for the case of providing an additional layer such as the surface treatment layer or the brightness-improving film, no more detailed description may be required for such a case.

### [Liquid Crystal Display Device]

The optical laminate of the present invention is advantageously used as a transmissive liquid crystal display device. In this case, the backlight is provided on the outer side of the first polarizing film 15 or the outer side of the second polarizing film 25, preferably at a side of the first polarizing film 15 opposite to the liquid crystal display glass cell 35 in the structure shown in FIG. 3, while the backlight is provided on a side of the brightness-improving film 17 opposite to the liquid crystal display glass cell 35 in the structure shown in FIG. 4, thereby obtaining a liquid crystal display device.

In the optical laminate of the present invention, or in a state where the set of polarizing films is bonded to the liquid crystal display glass cell, adhesive deposit, clouding, and the like are hardly observed on the surface of the glass substrate contacting with the adhesion layer even after the polarizing films are detached. Therefore, it is easy to bond polarizing films again to the liquid crystal display glass cell after the detachment of the polarizing film. That is, the optical laminate is excellent in the so-called reworkability.

The liquid crystal display device formed from the optical laminate is usable for a personal computer display including a notebook personal computer (PC), a desktop PC, and a personal digital assistant (PDA), a television, an in-vehicle display, an electronic dictionary, a digital camera, a digital video camera, an electronic desk calculator, a clock, and the like.

Hereinafter, the present invention will be described more specifically with reference to examples, which do not limit the scope of the present invention in any way. In the examples, “parts” and “%” each representing an amount or a content are based on weight unless otherwise indicated.

The nonvolatile content of the acrylic resin is a value measured by a method according to JIS K 5407. Specifically, the nonvolatile content is measured by drying an arbitrary weight of an adhesive solution which is placed on a petri dish in an explosion-proof oven at 115° C. for 2 hours and expressing the weight of residual nonvolatile components after drying by a ratio thereof to the weight of the solution measured before drying. A weight average molecular weight and a number average molecular weight were measured with a GPC device to which two “TSK gel G6000HXL” columns and two “TSK gel GMH_{HR}-H(S)” columns (both manufactured by Tosoh Corporation) were connected in series using tetrahydrofuran as an eluent under the conditions of a sample concentration of 5 mg/ml., a sample supply amount of 100 μl, a temperature of 40° C., and a flow rate of 1 ml/min. in terms of standard polystyrene-converted molecular weight.

To start with, the production examples of acrylic resins will be described.

### Polymerization Example 1

To a reactor equipped with a condenser, a nitrogen introduction tube, a thermometer and a stirrer, a mixture solution of 169.8 parts of ethyl acetate, 97.0 parts of butyl acrylate and 3.0 parts of acrylic acid was charged, and an inner temperature was raised to 55° C. while replacing an air inside the reactor with a nitrogen gas to achieve an oxygen-free atmosphere, followed by adding the whole amount of a solution prepared by dissolving 0.14 part of azobisisobutyronitrile (a polymerization initiator) in 5 parts of ethyl acetate.

After that, the reactor was kept warm while maintaining the inner temperature at 54° C. to 56° C. for 12 hours, and ethyl acetate was finally added to adjust a concentration of the acrylic resin to 20%. The thus-obtained acrylic resin had a weight average molecular weight Mw of 1,540,000 in terms of polystyrene by GPC and Mw/Mn of 4.69. This resin is referred to as Acrylic Resin A1.

### Polymerization Example 2

An acrylic resin solution was prepared in the same manner as in Polymerization Example 1 except for changing the monomer composition to 98.7 parts of butyl acrylate, 1.1 parts of acrylic acid and 0.2 part of 2-ethylhexyl acrylate. The thus-obtained acrylic resin had a weight average molecular weight Mw of 1,390,000 in terms of polystyrene by GPC and Mw/Mn of 3.53. This resin is referred to as Acrylic Resin A2.

### Polymerization Example 3

To a reactor equipped with a condenser, a nitrogen introduction tube, a thermometer and a stirrer, a mixture solution of 81.8 parts of ethyl acetate, 98.9 parts of butyl acrylate and 1.1 parts of acrylic acid was charged, and an inner temperature was raised to 55° C. while replacing an air inside the reactor with a nitrogen gas to achieve an oxygen-free atmosphere, followed by adding the whole amount of a solution prepared by dissolving 0.14 part of azobisisobutylonitrile (a polymerization initiator) in 10 parts of ethyl acetate.

After that, the reactor was kept warm while maintaining the inner temperature at 54° C. to 56° C. for 12 hours during which ethyl acetate was continuously added to the reactor at an adding rate of 17.3 parts/hr. so that the concentration of the acrylic resin excluding the monomers was maintained at 35%, and ethyl acetate was finally added to adjust a concentration of the acrylic resin to 20%. The thus-obtained acrylic resin had a weight average molecular weight Mw in terms of polystyrene by GPC of 1,200,000 and Mw/Mn of 3.9. This resin is referred to as Acrylic Resin A3.

### Polymerization Example 4

To the same reactor as that used in Polymerization Example 1, 222 parts of ethyl acetate, 35 parts of butyl acrylate, 44 parts of butyl methacrylate, 20 parts of methyl acrylate and 1 part of 2-hydroxyethyl acrylate were charged, and an inner temperature was raised to 75° C. after replacing an air inside the reactor with a nitrogen gas. Thereafter, the whole amount of a solution prepared by dissolving 0.55 part of azobisisobutylonitrile (a polymerization initiator) in 12.5 parts of ethyl acetate was added and then the reactor was kept warm for 8 hours while maintaining the inner temperature at 69° C. to 71° C., whereby the reaction was completed. The thus-obtained acrylic resin had a weight average molecular weight of 90,000 in terms of polystyrene by GPC. This resin is referred to as Acrylic Resin A4.

Next, the examples of producing adhesives using the acrylic resins produced as described above will be described. In these examples, the following materials (indicated by trade names) were used as crosslinking agents and a silane compound.

### Crosslinking Agent:

Colonate L: a solution of an adduct of tolylene diisocyanate with trimethylolpropane in ethyl acetate (a solid concentration of 75%) available form Nippon Polyurethane Industry, Co., Ltd.

TAZM: trimethylol propane tri-β-aziridinyl propionate (a liquid) available from Sogo Pharmaceutical Co., Ltd.

### Silane Compound:

X-41-1805: a silane oligomer having a mercapto group (a liquid) available from Shin-Etsu Chemical Co., Ltd.

### Production Example 1 of Adhesive

An adhesive solution was prepared by mixing 5 parts (a solid content) of the crosslinking agent “Colonate L” and 0.1 part of the silane compound “X-41-1805” based on 100 parts of the nonvolatile content of Acrylic Resin A1 obtained in Polymerization Example 1. The adhesive solution was applied to the release treatment surface of a polyethylene terephthalate film (trade name: PET 3811 available from Lintec Corporation; hereinafter referred to as a separator), which had been subjected to a release treatment, using an applicator so that a thickness after drying was 15 μm, followed by drying at 100° C. for one minute to obtain a sheet-form adhesive. This adhesive will be referred to as Adhesive 1.

### Production Example 2 of Adhesive

An adhesive solution was prepared by mixing 1.5 parts (a solid content) of the crosslinking agent “Colonate L” and 0.1 part of the silane compound “X-41-1805” based on 100 parts of the nonvolatile content of Acrylic Resin A2 obtained in Polymerization Example 2. The adhesive solution was applied to the release treatment surface of the same separator as that described above using an applicator so that a thickness after drying was 25 μm, followed by drying at 100° C. for one minute to obtain a sheet-form adhesive. This adhesive will be referred to as Adhesive 2.

### Production Example 3 of Adhesive

An ethyl acetate solution of acrylic resins was prepared by mixing Acrylic Resin A3 obtained in Polymerization Example 3 and Acrylic Resin A4 obtained in Polymerization Example 4 in a nonvolatile ratio of 70 to 30 (parts by weight).

An adhesive solution was prepared by mixing 2.3 parts (a solid content) of the crosslinking agent “Colonate L” and 0.1 part of the silane compound “X-41-1805” based on 100 parts of a solid content of the thus obtained solution. The adhesive solution was applied to the release treatment surface of the same separator as that described above using an applicator so that a thickness after drying was 25 μm, followed by drying at 100° C. for one minute to obtain a sheet-form adhesive. This adhesive will be referred to as Adhesive 3.

### Production Example 4 of Adhesive

An adhesive solution was prepared by mixing 2 parts (a solid content) of the crosslinking agent “Colonate L”, 0.02 part of “TAZM” and 0.1 part of the silane compound “X-41-1805” based on 100 parts of the nonvolatile content of Acrylic Resin A3 obtained in Polymerization Example 3. The adhesive solution was applied to the release treatment surface of the same separator as that described above using an applicator so that a thickness after drying was 15 μm, followed by drying at 100° C. for one minute to obtain a sheet-form adhesive. This adhesive will be referred to as Adhesive 4.

The acrylic resin composition, the contents of the crosslinking agent and the silane compound, the gel content, and the coating film thickness of each of Adhesives 1 to 4 are shown in Table 1.

TABLE 1

| | | | | | Silane | Coated | |
|---|---|---|---|---|---|---|---|
| | High Molecular | Low Molecular | Crosslinking Agent | | Compound | Film | Gel |
| | Weight Acrylic | Weight Acrylic | (parts) | | X-41-1805 | Thickness | Content |
| | resin | resin | Colonate L | TAZM | (parts) | (μm) | (%) |
| Adhesive 1 | A1/100 parts | — | 5.0 | — | 0.1 | 15 | 80.2 |
| Adhesive 2 | A2/100 parts | — | 1.5 | — | 0.1 | 25 | 82.9 |
| Adhesive 3 | A3/70 parts | A4/30 parts | 2.3 | — | 0.1 | 25 | 61.8 |
| Adhesive 4 | A3/100 parts | — | 2.0 | 0.02 | 0.1 | 15 | 75.5 |

Hereinafter, Examples and Comparative Examples, in which a polarizing film with an adhesive was produced and then an optical laminate was produced by applying the polarizing film with the adhesive to a glass substrate, will be described. A process for producing an optical laminate 1 will be described with reference to reference numerals shown in FIG. 3. Firstly, the examples of bonding the first polarizing film having the structure of norbornene resin film/polyvinyl alcohol-based polarizer/triacetylcellulose protection film to one surface of a liquid crystal display glass cell and bonding the second polarizing film having the structure of triacetylcellulose protection film/polyvinyl alcohol-based polarizer/triacetylcellulose protection film to the other surface will be described.

### Example 1

### (a) Production of Polarizing Film with Adhesive

The first polarizing film 15 having the structure of norbornene resin film/polyvinyl alcohol-based polarizer/triacetylcellulose protection film was supplied. After performing a corona discharge treatment on the surface of the norbornene resin film 12 under the conditions of an output power of 600 W and a transfer rate of 10 m/min., the adhesive side of Adhesive 1 (gel content: 80.2%, film thickness: 15 μm) with the separator, which was previously obtained and in the form of a sheet, was bonded to the corona discharge-treated surface, followed by aging under the conditions of a temperature of 23° C. and a relative humidity of 65% for 10 days to form the first adhesion layer 11 on the surface of the norbornene resin film 12 of the first polarizing film 15, thereby obtaining the first polarizing film 10 with the adhesive.

Separately, the second polarizing film 25 having the structure of triacetylcellulose protection film/polyvinyl alcohol-based polarizer/triacetylcellulose protection film and having an anti-reflection layer formed on the surface of one of the protection films was supplied, and the adhesive side of Adhesive 3 (gel content: 61.8%, film thickness: 25 μm) with the separator, which was previously obtained and in the form of a sheet, was bonded to the surface of the protection film on the side to which the anti-reflection layer is not provided, followed by aging under the conditions of a temperature of 23° C. and a relative humidity of 65% for 10 days to form the second adhesion layer 21 on the surface of the protection film 22 of the second polarizing film 25, thereby obtaining the second polarizing film 20 with the adhesive.

### (b) Production of Optical Laminate

The first polarizing film 10 with the adhesive was bonded to one surface of a liquid crystal display glass substrate 35 (“1737” (trade name) manufactured by Corning Incorporated) after peeling off the separator from the adhesion layer 11, and the second polarizing film 20 with the adhesive was bonded to the other surface of the glass substrate after peeling off the separator from the adhesion layer 21. In this case, the first polarizing film 15 and the second polarizing film 25 were bonded so as to form cross nicol. Thus, an optical laminate 30, in which the anti-reflection layer, the second polarizing film 25, the second adhesion layer 21, the glass substrate 35, the first adhesion layer 11, and the first polarizing film 15 having the structure of norbornene resin film 12/polarizer 13/protection film 14 were laminated in this order, was produced. Each of the two polarizing films had a rectangular shape having a size of 30 cm×22 cm (15-inch type).

### (c) Evaluation of Durability

After conducting a heat resistance test by storing the optical laminate under the dry condition at a temperature of 80° C. for 96 hours, a state of the occurrence of white spots was visually observed. Also, the durability of the optical laminate was evaluated after conducting the heat resistance test under the above-described conditions, after conducting a heat and humidity resistance test by storing the optical laminate at a temperature of 60° C. and a relative humidity of 90% for 96 hours, and after conducting a heat shock resistance test (abbreviated as HS resistance test in the table) by repeating a cycle (1 hour) of heating to 70° C., lowering the temperature to −30° C., and heating to 70° C. for 100 times. The results are categorized as follows and summarized in Table 2.

### <Occurrence of White Spot>

The occurrence of white spots when light was made incident from the first polarizing film side was evaluated by the following 4-level rating:

A: no white spots.
B: white spots are hardly observed.
C: white spots are somewhat observed.
D: white spots are remarkably observed.

### <Durability Evaluation>

The durability of the optical laminate was evaluated by the following 4-level rating after conducting the heat resistance test, after conducting the heat and humidity resistance test, and after conducting the heat shock test:

A: Appearance changes such as warping, peeling, and foaming are not observed at all.
B: Appearance changes such as warping, peeling, and foaming are hardly observed.
C: Appearance changes such as warping, peeling, and foaming are somewhat observed.
D: Appearance changes such as warping, peeling, and foaming are remarkably observed.

### (d) Evaluation of Reworkability

A test piece having a size of 25 mm×150 mm was cut out from each of the two types of polarizing films with adhesive produced in (a). The test pieces were bonded to a liquid crystal display glass cell substrate using a bonding machine [Lami-Packer (trade name) manufactured by Fuji Plastic Machine Limited], followed by treatment in an autoclave at 50° C. under 5 kg/cm² (490.3 kPa) for 20 minutes. Subsequently, a heating treatment was performed at 70° C. for 2 hours, followed by storage in an oven at 50° C. for 48 hours, and the polarizing films were detached at a rate of 300 mm/min. in a direction of 180° from the adhesion test pieces at a temperature of 23° C. and a relative humidity of 50%. Thereafter, the surface of the glass plate was observed. As a result, no adhesive deposit of each of the two types of polarizing films with adhesive was observed on the glass plate surface, and clouding and the like were hardly observed, thereby proving good reworkability.

### Example 2

A polarizing film with an adhesive was produced in the same manner as in Example 1 except for changing the adhesive to be bonded to the surface of the norbornene resin film 12 of the first polarizing film 15 having the structure of norbornene resin film/polyvinyl alcohol-based polarizer/triacetylcellulose protection film to Adhesive 2 (gel content: 82.9%, film thickness: 25 μm) in the form of a sheet and with a separator which had been previously obtained, and then an optical laminate was produced. The optical laminate was subjected to the same evaluation as that of (c) of Example 1, and the results are also shown in Table 2. Further, the reworkability evaluation was conducted in the same manner as in (d) of Example 1 on the polarizing film with the adhesive in which Adhesive 2 with the separator was used for the surface of the norbornene resin film 12 of the thus-obtained first polarizing film 15. As a result, no adhesive deposit was observed on the glass plate surface, and clouding and the like were hardly observed, thereby proving good reworkability.

### Example 3

An optical laminate was produced and evaluated in the same manners as in Example 1 except for changing the adhesive to be bonded to the surface of the norbornene resin film 12 of the first polarizing film 15 and the adhesive of the second polarizing film 25 to be bonded to the protection film surface on which the anti-reflection layer was not provided to Adhesive 1 (gel content 80.2%, film thickness: 15 μm) described in the production example of an adhesive. The results are shown in Table 2.

### Comparative Example 1

An optical laminate was produced and evaluation was conducted in the same manner as in Example 1 except for changing the adhesive to be bonded to the surface of the norbornene resin film 12 of the first polarizing film 15 and the adhesive of the second polarizing film 25 to be bonded to the protection film surface on which the anti-reflection layer was not provided to Adhesive 3 (gel content 61.8%, film thickness: 25 μm) described in the production example of an adhesive. The results are shown in Table 2.

### Comparative Example 2

An optical laminate was produced and evaluated in the same manners as in Example 1 except for changing the adhesive to be bonded to the surface of the norbornene resin film 12 of the first polarizing film 15 to Adhesive 3 (gel content 61.8%, film thickness: 25 μm) described in the production example of an adhesive, and changing the adhesive of the second polarizing film 25 to be bonded to the protection film surface on which the anti-reflection layer was not provided to Adhesive 1 (gel content 80.2%, film thickness: 15 μm) described in the production example of an adhesive. The results are shown in Table 2.

TABLE 2

| | | | | | Heat and | |
|---|---|---|---|---|---|---|
| | | | | | Humidity | HS |
| | First | Second | | | Resistance | Resistance |
| | Adhesion | Adhesion | Heat Resistance Test | | Test | Test |
| | Layer | Layer | White Spots | Durability | Durability | Durability |
| Example 1 | Adhesive 1 | Adhesive 3 | A | A | A | A |
| Example 2 | Adhesive 2 | Adhesive 3 | B | A | A | A |
| Example 3 | Adhesive 1 | Adhesive 1 | C | A | A | A |
| Comp. Ex. 1 | Adhesive 3 | Adhesive 3 | A | D | D | D |
| Comp. Ex. 2 | Adhesive 3 | Adhesive 1 | C | D | D | D |

In Examples 1 to 3, in which the first adhesion layer provided on the amorphous cyclic polyolefin resin film side of the first polarizing film having the amorphous cyclic polyolefin resin film was formed of Adhesive 1 or Adhesive 2 having the high gel content and in turn the high aggregation force, the adhesion force was enhanced to exhibit the high durability since the first adhesion layer was bonded to the amorphous cyclic polyolefin resin film. Also, Examples 1 and 2, in which the second adhesion layer provided on the cellulose-based protection film side of the conventional polarizing film (the second polarizing film) having the cellulose-based protection film was formed from Adhesive 3 having the low gel content and in turn the low aggregation force, could alleviate a stress between the polarizing film and the glass surface at the second adhesion layer side, thereby also suppressing white spots.

Although somewhat visible white spots occurred because of the dimensional change of the second polarizing film caused by heat in Example 3 in which Adhesive 1 having the high gel content and in turn the high aggregation force was also used on the second polarizing film side, the optical laminate of Example 3 could be satisfactorily used depending on the application and needs of liquid crystal panel manufacturers.

In contrast, the optical laminate of Comparative Example 1, in which both of the adhesion layers were formed from Adhesive 3 having the low gel content and in turn the low aggregation force, had inferior durability though exhibited a good result in terms of white spots, since Adhesive 3 having the small aggregation force was used for the optical laminate. The optical laminate of Comparative Example 2, in which Adhesive 3 having the low gel content was used for the first polarizing film side and Adhesive 1 having the high gel content was used for the second polarizing film side, had inferior durability because Adhesive 3 having the small aggregation force was used on the first polarizing film side.

Hereinafter, examples of bonding a polarizing film having the structure of norbornene-based rein film/polyvinyl alcohol-based polarizer/triacetylcellulose protection film to the both surfaces of a liquid crystal display glass cell will be described.

### Example 4

### (a) Production of Polarizing Film with Adhesive

The first polarizing film 15 having the structure of norbornene resin film/polyvinyl alcohol-based polarizer/triacetylcellulose protection film was supplied. After performing a corona discharge treatment on the surface of the norbornene resin film 12 under the conditions of an output power of 600 W and a transfer rate of 10 m/min., the adhesive side of Adhesive 1 (gel content: 80.2%, film thickness: 15 μm) with the separator, which was produced in the above production example of an adhesive and in the form of a sheet, was bonded to the corona discharge-treated surface using a laminator, followed by aging under the conditions of a temperature of 23° C. and a relative humidity of 65% for 10 days to form the first adhesion layer 11 on the surface of the norbornene resin film 12 of the first polarizing film 15, thereby obtaining the first polarizing film 10 with the adhesive.

Separately, the second polarizing film 25 having the structure of norbornene resin film/polyvinyl alcohol-based polarizer/triacetylcellulose protection film and having an anti-reflection layer formed on the surface of the triacetylcellulose protection film was supplied. After performing a corona discharge treatment on the surface of the norbornene resin film 22 under the conditions of an output power of 600 W and a transfer rate of 10 m/min., the adhesive side of Adhesive 1 (gel content: 80.2%, film thickness: 15 μm) with the separator, which was produced in the production example of an adhesive and in the form of a sheet, was bonded to the corona discharge-treated surface using a laminator, followed by aging under the conditions of a temperature of 23° C. and a relative humidity of 65% for 10 days to form the second adhesion layer 21 on the surface of the norbornene resin protection film 22 of the second polarizing film 25, thereby obtaining the second polarizing film 20 with the adhesive.

### (b) Production of Optical Laminate

The first polarizing film 10 with the adhesive was bonded to one surface of the liquid crystal display glass substrate 35 (“1737” (trade name) manufactured by Corning Incorporated) after peeling off the separator from the adhesion layer 11, and the second polarizing film 20 with the adhesive was bonded to the other surface of the glass substrate after peeling off the separator from the adhesion layer 21. In this case, the first polarizing film 15 and the second polarizing film 25 were bonded so as to form cross nicol. Thus, an optical laminate 30 in which the anti-reflection layer, the second polarizing film 25 having the structure of protection film 24/polarizer 23/norbornene resin film 22)/second adhesion layer 21/glass substrate 35/first adhesion layer 11 and the first polarizing film 15 having the structure of norbornene resin film 12/polarizer 13/protection film 14 were laminated in this order was produced. Each of the two polarizing films had a rectangular shape having a size of 30 cm×22 cm (15-inch type).

### (c) Evaluation of Durability

The optical laminate obtained as described above was subjected to the evaluation of durability in the same manner as in (c) of Example 1, and the results are shown in Table 3.

### (d) Evaluation of Reworkability

Evaluation of reworkability was conducted on each of the two types of polarizing films with the adhesive produced in (a) above in the same manner as in (d) of Example 1. As a result, for each of the two types of polarizing films with the adhesive, no adhesive deposit was observed on the glass plate surface, and clouding and the like were hardly observed, thereby proving good reworkability.

### Example 5

A polarizing film with an adhesive and then an optical laminate were produced in the same manners as in Example 4 except for changing the adhesives to be bonded to the surfaces of the norbornene resin films 12 and 22 of the first polarizing film 15 and the second polarizing film 25, respectively, to Adhesive 4 (gel content: 75.5%, film thickness: 15 μm) with the separator that was described in the production example of an adhesive and in the form of a sheet. The optical laminate was evaluated in the same manner as in (c) of Example 4, and the results are shown in Table 3.

The reworkability was evaluated on each of the two types of polarizing films with the adhesives produced as described above in the same manner as in (d) of Example 4. As a result, for each of the two types of polarizing films with adhesive, no adhesive deposit was observed on the glass plate surface, and clouding and the like were hardly observed, thereby proving good reworkability.

### Comparative Example 3

A polarizing film with an adhesive and then an optical laminate were produced in the same manners as in Example 4 except for changing the adhesive to be bonded to the surface of the norbornene resin film 22 of the second polarizing film 25 to Adhesive 3 (gel content 61.8%, film thickness: 25 μm) with the separator described in the production example of an adhesive and in the form of a sheet. The optical laminate was evaluated in the same manner as in (c) of Example 4, and the results are shown in Table 3. The reworkability was evaluated on the polarizing film with the adhesive newly produced in this Comparative Example in the same manner as in (d) of Example 4. As a result, no adhesive deposit was observed on the glass plate surface, and clouding and the like were hardly observed, thereby proving good reworkability.

### Comparative Example 4

A polarizing film with an adhesive and then an optical laminate were produced in the same manners as in Example 4 except for changing the adhesive to be bonded to the surface of the norbornene resin film 12 of the first polarizing film 15 to Adhesive 3 (gel content 61.8%, film thickness: 25 μm) with the separator described in the production example of an adhesive and in the form of a sheet. The optical laminate was evaluated in the same manner as in (c) of Example 4, and the results are shown in Table 3. The reworkability was evaluated on the polarizing film with the adhesive newly produced in this Comparative Example in the same manner as in (d) of Example 4. As a result, no adhesive deposit was observed on the glass plate surface, and clouding and the like were hardly observed, thereby proving good reworkability.

### Comparative Example 5

A polarizing film with an adhesive and then an optical laminate were produced in the same manners as in Example 4 except for changing the adhesive to be bonded to each of the surfaces of the norbornene resin films 12 and 22 of the first polarizing film 15 and the second polarizing film 25, respectively, to Adhesive 3 (gel content 61.8%, film thickness: 25 μm) with the separator used in Comparative Examples 3 and 4 and in the form of a sheet. The optical laminate was evaluated in the same manner as in (c) of Example 4, and the results are shown in Table 3.

TABLE 3
Norbornene resin protection film/glass cell/norbornene resin protection film

| | | | | | Heat and | |
|---|---|---|---|---|---|---|
| | | | | | Humidity | HS |
| | First | Second | | | Resistance | Resistance |
| | Adhesion | Adhesion | Heat Resistance Test | | Test | Test |
| | Layer | Layer | White Spot | Durability | Durability | Durability |
| Example 4 | Adhesive 1 | Adhesive 1 | A | A | A | A |
| Example 5 | Adhesive 4 | Adhesive 4 | A | A | A | A |
| Comp. Ex. 3 | Adhesive 1 | Adhesive 3 | A | D | D | D |
| Comp. Ex. 4 | Adhesive 3 | Adhesive 1 | A | D | D | D |
| Comp. Ex. 5 | Adhesive 3 | Adhesive 3 | A | D | D | D |

In each of Examples 4 and 5, the adhesion force was enhanced to exhibit the high durability, since in these Examples, the adhesion layer was formed from Adhesive 1 or Adhesive 4 having the high gel content and in turn the high aggregation force for laminating the amorphous cyclic polyolefin resin film side of the polarizing film having the amorphous cyclic polyolefin resin film on the respective surface of the liquid crystal display glass cell with interposing the adhesion layer. In contrast, the optical laminates of Comparative Examples 3 to 5 in which one or both of the adhesion layers was/were formed from Adhesive 3 having the low gel content and in turn the low aggregation force had inferior durability although they exhibited a good result in terms of white spots.

### INDUSTRIAL APPLICABILITY

Since the optical laminate comprising the polarizing film with the adhesive or the set of polarizing films of the present invention is free from white spots even in large size displays and excellent in durability, the optical laminate can be suitably used for liquid crystal display devices. For example, the optical laminate is suitably used as an optical laminate of a TN liquid crystal cell or the like. Also, when the optical laminate is used for a STN liquid crystal cell, the occurrence of color irregularity can be suppressed.

1. A polarizing film with an adhesive comprising a polarizing film having a structure of amorphous cyclic polyolefin resin film/polarizer/protection film and an adhesion layer provided on an outer side of the amorphous cyclic polyolefin resin film, wherein the adhesion layer has a gel content of 75 to 95 wt %.

2. The polarizing film with the adhesive according to claim 1, wherein the adhesion layer is formed from an adhesive prepared by mixing an acrylic resin with a crosslinking agent.

3. The polarizing film with the adhesive according to claim 2, wherein the adhesive comprises an acrylic resin comprising structural units derived from an alkyl (meth)acrylate as a main component and structural units derived from a (meth)acrylic acid compound having a polar functional group.

4. The polarizing film with the adhesive according to claim 3, wherein the polar functional group is selected from the group consisting of a free carboxyl group, a hydroxyl group, an amino group and an epoxy ring.

5. The polarizing film with the adhesive according to claim 3, wherein the adhesive comprises an acrylic resin comprising structural units derived from an alkyl (meth)acrylate as a main component and having a weight average molecular weight of 1,000,000 to 2,000,000.

6. The polarizing film with the adhesive according to claim 2, wherein the crosslinking agent comprises an isocyanate compound.

7. The polarizing film with the adhesive according to claim 2, wherein the adhesive further comprises a silane compound.

8. The polarizing film with the adhesive according to claim 1, wherein the adhesion layer has a thickness of 20 μm or less.

9. The polarizing film with the adhesive according to claim 1, which further comprises a brightness-improving film that is laminated on an outer side of the protection film.

10. An optical laminate wherein the polarizing film with the adhesive defined in claim 1 is bonded to one surface of a liquid crystal display glass cell at the adhesion layer side of the polarizing film with the adhesive.

11. An optical laminate wherein the first polarizing film having a structure of amorphous cyclic polyolefin resin film/polarizer/protection film is bonded to one surface of the liquid crystal display glass cell at the amorphous cyclic polyolefin resin film side of the first polarizing film with interposing the first adhesion layer; and the second polarizing film in which an acetylcellulose-based protection film is bonded to each of surfaces of a polarizer is bonded to the other surface of the glass cell with interposing the second adhesion layer, the first adhesion layer has a gel content of 75 to 95 wt %, and the second adhesion layer has a gel content of 30 to 70 wt %.

12. The optical laminate according to claim 11, wherein the second polarizing film has a surface treatment layer on a surface opposite to the second adhesion layer.

13. The optical laminate according to claim 11, which further comprises a brightness-improving film that is laminated on an outer side of the protection film of the first polarizing film.

14. The optical laminate according to claim 11, wherein each of the first adhesion layer and the second adhesion layer is formed from an adhesive prepared by mixing an acrylic resin with a crosslinking agent.

15. The optical laminate according to claim 14, wherein the adhesive forming each of the first adhesion layer and the second adhesion layer comprises the first acrylic resin comprising structural units derived from an alkyl (meth)acrylate as a main component and structural units derived from a (meth)acrylic acid compound having a polar functional group and having a weight average molecular weight of 1,000,000 to 2,000,000.

16. The optical laminate according to claim 15, wherein the adhesive forming the second adhesion layer comprises the first acrylic resin and the second acrylic resin comprising structural units derived from an alkyl (meth)acrylate as a main component and having a weight average molecular weight of 50,000 to 500,000.

17. The optical laminate according to claim 14, wherein the adhesive forming each of the first adhesion layer and the second adhesion layer further comprises a silane compound.

18. An optical laminate wherein the first polarizing film having a structure of amorphous cyclic polyolefin resin film/polarizer/protection film is bonded to one surface of the liquid crystal display glass cell at the amorphous cyclic polyolefin resin film side of the first polarizing film with interposing the first adhesion layer; and the second polarizing film having a structure of amorphous cyclic polyolefin resin film/polarizer/protection film is bonded to the other surface of the glass cell at the amorphous cyclic polyolefin resin film side of the second polarizing film with interposing the second adhesion layer, and each of the first adhesion layer and the second adhesion layer has a gel content of 75 to 95 wt %.

19. The optical laminate according to claim 18, wherein the second polarizing film has a surface treatment layer on a surface opposite to the second adhesion layer.

20. The optical laminate according to claim 18, which further comprises a brightness-improving film that is laminated on an outer side of the protection film of the first polarizing film.

21. The optical laminate according to claim 18, wherein each of the first adhesion layer and the second adhesion layer is formed from an adhesive prepared by mixing an acrylic resin with a crosslinking agent.

22. The optical laminate according to claim 21, wherein the adhesive forming the first adhesion layer and the second adhesion layer comprises the first acrylic resin comprising structural units derived from an alkyl (meth)acrylate as a main component and structural units derived from a (meth)acrylic acid compound having a polar functional group and having a weight average molecular weight of 1,000,000 to 2,000,000.

23. The optical laminate according to claim 21, wherein the adhesive forming the first adhesion layer and the second adhesion layer further comprises a silane compound.

24. A set of polarizing films for a liquid crystal display device comprising:
the first polarizing film with an adhesive and the second polarizing film with an adhesive, wherein the first polarizing film with the adhesive comprises the first polarizing film having a structure of amorphous cyclic polyolefin resin film/polarizer/protection film and the first adhesion layer provided on an outer side of the amorphous cyclic polyolefin resin film and
the second polarizing film with the adhesive comprises the second polarizing film in which an acetylcellulose-based protection film is bonded to each of the both surfaces of a polarizer and the second adhesion layer provided on one surface of the second polarizing film, wherein
the first adhesion layer has a gel content of 75 to 95 wt % and
the second adhesion layer has a gel content of 30 to 70 wt %.

25. The set of polarizing films according to claim 24, wherein the second polarizing film with the adhesive has a surface treatment layer on a surface opposite to the second adhesion layer.

26. A method for producing a polarizing film with an adhesive wherein, when an adhesion layer is provided on an amorphous cyclic polyolefin resin film side of a polarizing film having a structure of amorphous cyclic polyolefin resin film/polarizer/protection film, the adhesion layer is provided on a surface of the amorphous cyclic polyolefin resin film of the polarizing film with adjusting a gel content of the adhesion layer to 75 to 95 wt %.

27. The method according to claim 26, wherein a corona discharge treatment is performed on the surface of the amorphous polyolefin resin film before providing the adhesion layer on the surface of the amorphous polyolefin resin film.

28. The method according to claim 27, wherein the corona discharge treatment is performed at an output power of 200 to 1,000 W.
